(19) United States
(12) Patent Application Publication
(10) Pub. No.: US 2016/0259155 A1
(43) Pub. Date: Sep. 8, 2016

(54) ZOOM LENS AND IMAGING APPARATUS

(71) Applicant: FUJIFILM Corporation, Tokyo (JP)

(72) Inventors: Yasutaka SHIMADA, Saitama-shi (JP); Michio CHO, Saitama-shi (JP)

(73) Assignee: FUJIFILM Corporation, Tokyo (JP)

(21) Appl. No.: 15/017,006

(22) Filed: Feb. 5, 2016

(30) Foreign Application Priority Data
Mar. 6, 2015 (JP) 2015-045034

(51) Int. Cl. G02B 15/173; G02B 27/00

(52) U.S. Cl. CPC G02B 15/173; G02B 27/005

(57) ABSTRACT

A zoom lens consists of five lens groups consisting of, in order from the object side, positive, negative, positive, positive, and positive lens groups, wherein the first and fifth lens groups are fixed relative to the image plane during magnification change, the second to fourth lens groups are moved to change distances therebetween during magnification change, the second lens group is moved from the object side toward the image plane side during magnification change from the wide angle end to the telephoto end, the second lens group includes at least one positive lens and at least four negative lenses including three negative lenses that are successively disposed from the most object side, and satisfies the condition expressions (1) and (2) below:

25<νd21<45 (1), and

0.31<f2/f21<0.7 (2).

### CROSS-REFERENCE TO RELATED APPLICATIONS

The present application claims priority under 35 U.S.C. §119 to Japanese Patent Application No. 2015-045034, filed on Mar. 6, 2015. The above application is hereby expressly incorporated by reference, in its entirety, into the present application.

### BACKGROUND

The present disclosure relates to a zoom lens for use with electronic cameras, such as digital cameras, video cameras, broadcasting cameras, monitoring cameras, etc., as well as an imaging apparatus provided with the zoom lens.

As high magnification zoom lenses for television cameras, those having a five-group configuration as a whole for achieving high performance, wherein three lens groups are moved during magnification change, are proposed in Japanese Unexamined Patent Publication Nos. 2009-128491, 2013-092557, 2014-038238, and 2014-081464 (hereinafter, Patent Documents 1 to 4, respectively).

### SUMMARY

However, the zoom lens of Patent Document 1 does not have a sufficiently high magnification ratio. Further, the zoom lenses of Patent Documents 1 to 4 have not small fluctuations of secondary longitudinal chromatic aberration and secondary lateral chromatic aberration during magnification change, and a zoom lens having successfully suppressed fluctuations of secondary longitudinal chromatic aberration and secondary lateral chromatic aberration is desired.

In view of the above-described circumstances, the present disclosure is directed to providing a high performance zoom lens having suppressed fluctuations of primary and secondary longitudinal chromatic aberrations and primary and secondary lateral chromatic aberrations during magnification change while achieving high magnification ratio, as well as an imaging apparatus provided with the zoom lens.

A zoom lens of the disclosure consists of, in order from the object side, a first lens group having a positive refractive power, a second lens group having a negative refractive power, a third lens group having a positive refractive power, a fourth lens group having a positive refractive power, and a fifth lens group having a positive refractive power, wherein the first lens group and the fifth lens group are fixed relative to the image plane during magnification change, the second lens group, the third lens group, and the fourth lens group are moved to change distances therebetween during magnification change, the second lens group is moved from the object side toward the image plane side during magnification change from the wide angle end to the telephoto end, the second lens group includes at least one positive lens and at least four negative lenses including three negative lenses that are successively disposed from the most object side, and the second lens group and an L21 negative lens, which is the most object-side lens of the negative lenses of the second lens group, satisfy the condition expressions (1) and (2) below:

25<νd21<45 (1), and

0.31<f2/f21<0.7 (2),

where νd21 is an Abbe number with respect to the d-line of the L21 negative lens, f2 is a focal length with respect to the d-line of the second lens group, and f21 is a focal length with respect to the d-line of the L21 negative lens.

It is preferred that the condition expression (1-1) and/or (2-1) below be satisfied:

28<νd21<40 (1-1),

0.36<f2/f21<0.55 (2-1).

In the zoom lens of the disclosure, it is preferred that the condition expression (3) below be satisfied. It is more preferred that the condition expression (3-1) below be satisfied.

−0.3<fw/f21<−0.105 (3),

−0.2<fw/f21<−0.11 (3-1),

where fw is a focal length with respect to the d-line of the entire system at the wide angle end, and f21 is a focal length with respect to the d-line of the L21 negative lens.

It is preferred that the second lens group consist of, in order from the object side, the L21 negative lens, an L22 negative lens, a cemented lens formed by, in order from the object side, an L23 negative lens having a biconcave shape and an L24 positive lens that are cemented together, and a cemented lens formed by, in order from the object side, an L25 positive lens having a convex surface toward the image plane side and an L26 negative lens that are cemented together.

In this case, it is preferred that the condition expression (4) below be satisfied:

L23νd−L24νd<L26νd−L25νd (4),

where L23νd is an Abbe number with respect to the d-line of the L23 negative lens, L24νd is an Abbe number with respect to the d-line of the L24 positive lens, L26νd is an Abbe number with respect to the d-line of the L26 negative lens, and L25νd is an Abbe number with respect to the d-line of the L25 positive lens.

It is preferred that the first lens group consist of, in order from the object side, an L11 negative lens, an L12 positive lens, an L13 positive lens, an L14 positive lens, and an L15 positive lens having a meniscus shape with the convex surface toward the object side, and satisfy the condition expressions (5) and (6) below. It is more preferred that the condition expression (5-1) and/or (6-1) below be satisfied.

1.75<ndL11 (5),

1.80<ndL11 (5-1),

νdL11<45 (6),

νdL11<40 (6-1),

where ndL11 is a refractive index with respect to the d-line of the L11 negative lens, and νdL11 is an Abbe number with respect to the d-line of the L11 negative lens.

It is preferred that the position of the fourth lens group at the telephoto end be nearer to the object side than the position of the fourth lens group at the wide angle end.

It is preferred that the distance between the second lens group and the third lens group at the telephoto end be smaller than the distance between the second lens group and the third lens group at the wide angle end.

It is preferred that the fifth lens group include at least two negative lenses, and satisfy the condition expression (7) below. It is more preferred that the condition expression (7-1) below be satisfied.

1.90<LABnd (7),

1.94<LABnd (7-1),

where LABnd is an average value of a refractive index LAnd with respect to the d-line of an LA negative lens that is the first negative lens from the image plane side of the fifth lens group and a refractive index LBnd with respect to the d-line of an LB negative lens that is the second negative lens from the image plane side of the fifth lens group.

In this case, it is preferred that the condition expression (8) below be satisfied. It is more preferred that the condition expression (8-1) below be satisfied.

0.42<LAnd−LCnd (8),

0.45<LAnd−LCnd (8-1),

where LAnd is a refractive index with respect to the d-line of the LA negative lens that is the first negative lens from the image plane side of the fifth lens group, and LCnd is a refractive index with respect to the d-line of an LC positive lens that is the first positive lens from the image plane side of the fifth lens group.

It is preferred that the fifth lens group include at least two negative lenses, and satisfy the condition expression (9) below. It is more preferred that the condition expression (9-1) below be satisfied.

25<LABνd<40 (9),

30<LABνd<36 (9-1),

where LABνd is an average value of an Abbe number LAνd with respect to the d-line of the LA negative lens that is the first negative lens from the image plane side of the fifth lens group and an Abbe number LBνd with respect to the d-line of the LB negative lens that is the second negative lens from the image plane side of the fifth lens group.

It is preferred that, during magnification change from the wide angle end to the telephoto end, each of the second lens group and a third-fourth combined lens group, which is formed by the third lens group and the fourth lens group, simultaneously pass through a point at which the imaging magnification of the lens group is −1×.

It is preferred that the distance between the third lens group and the fourth lens group be the greatest at a point on the wide angle side of the point at which the imaging magnification of the third-fourth combined lens group, which is formed by the third lens group and the fourth lens group, is −1×.

It is preferred that the third-fourth combined lens group, which is formed by the third lens group and the fourth lens group, include at least one negative lens, and satisfy the condition expression (10) below. It is more preferred that the condition expression (10-1) below be satisfied.

29<νdG34n<37 (10),

29.5<νdG34n<36 (10-1),

where νdG34n is an average value of Abbe numbers with respect to the d-line of all negative lenses of the third-fourth combined lens group.

An imaging apparatus of the disclosure comprises the above-described zoom lens of the disclosure.

It should be noted that the expression “consisting/consist of” as used herein means that the zoom lens may include, besides the elements recited above: lenses without any power; optical elements other than lenses, such as a stop, a mask, a cover glass, and filters; and mechanical components, such as a lens flange, a lens barrel, an image sensor, a camera shake correction mechanism, etc.

The sign (positive or negative) with respect to the surface shape and the refractive power of any lens including an aspheric surface among the lenses described above is about the paraxial region.

The zoom lens of the disclosure consists of, in order from the object side, a first lens group having a positive refractive power, a second lens group having a negative refractive power, a third lens group having a positive refractive power, a fourth lens group having a positive refractive power, and a fifth lens group having a positive refractive power, wherein, the first lens group and the fifth lens group are fixed relative to the image plane during magnification change, the second lens group, the third lens group, and the fourth lens group are moved to change distances therebetween during magnification change, the second lens group is moved from the object side toward the image plane side during magnification change from the wide angle end to the telephoto end, the second lens group includes at least one positive lens and at least four negative lenses including three negative lenses that are successively disposed from the most object side, and the second lens group and an L21 negative lens, which is the most object-side lens of the negative lenses of the second lens group, satisfy the condition expressions (1) and (2) below:

25<νd21<45 (1), and

0.31<f2/f21<0.7 (2).

This configuration allows providing a high performance zoom lens having suppressed fluctuations of primary and secondary longitudinal chromatic aberrations and primary and secondary lateral chromatic aberrations during magnification change while achieving high magnification ratio.

The imaging apparatus of the disclosure, which is provided with the zoom lens of the disclosure, allows obtaining a high image-quality image at high magnification.

### BRIEF DESCRIPTION OF THE DRAWINGS

FIG. 1 is a sectional view illustrating the lens configuration of a zoom lens according to one embodiment of the disclosure (a zoom lens of Example 1),

FIG. 2 is a diagram showing optical paths through the zoom lens according to one embodiment of the disclosure (the zoom lens of Example 1),

FIG. 3 is a sectional view illustrating the lens configuration of a zoom lens of Example 2 of the disclosure,

FIG. 4 is a diagram showing optical paths through the zoom lens of Example 2 of the disclosure,

FIG. 5 is a sectional view illustrating the lens configuration of a zoom lens of Example 3 of the disclosure,

FIG. 6 is a diagram showing optical paths through the zoom lens of Example 3 of the disclosure,

FIG. 7 is a sectional view illustrating the lens configuration of a zoom lens of Example 4 of the disclosure,

FIG. 8 is a diagram showing optical paths through the zoom lens of Example 4 of the disclosure,

FIG. 9 shows aberration diagrams of the zoom lens of Example 1 of the disclosure,

FIG. 10 shows aberration diagrams of the zoom lens of Example 2 of the disclosure,

FIG. 11 shows aberration diagrams of the zoom lens of Example 3 of the disclosure,

FIG. 12 shows aberration diagrams of the zoom lens of Example 4 of the disclosure, and

FIG. 13 is a diagram illustrating the schematic configuration of an imaging apparatus according to an embodiment of the disclosure.

### DETAILED DESCRIPTION OF THE PREFERRED EMBODIMENTS

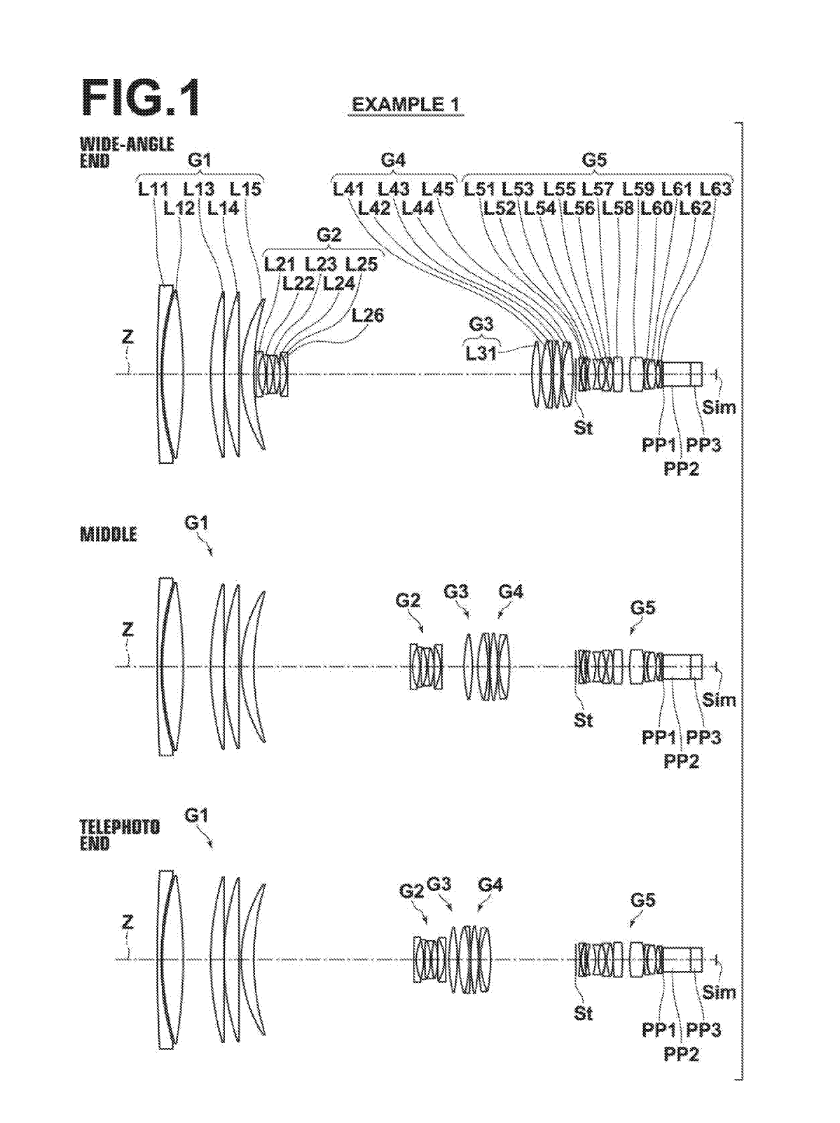

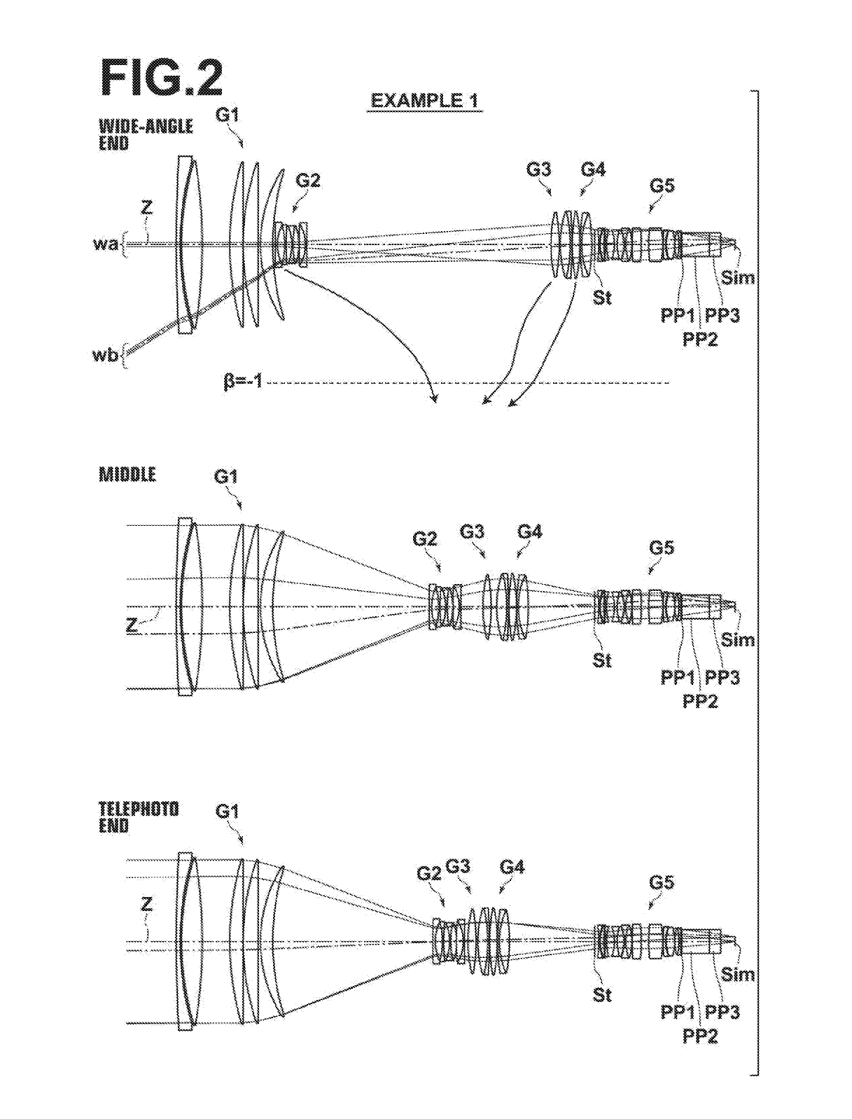

Hereinafter, embodiments of the present disclosure will be described in detail with reference to the drawings. FIG. 1 is a sectional view illustrating the lens configuration of a zoom lens according to one embodiment of the disclosure, and FIG. 2 is a diagram showing optical paths through the zoom lens. The configuration example shown in FIGS. 1 and 2 is the same as the configuration of a zoom lens of Example 1, which will be described later. In FIGS. 1 and 2, the left side is the object side and the right side is the image plane side. An aperture stop St shown in each drawing does not necessarily represent the size and the shape thereof, but represents the position thereof along the optical axis Z. In the diagram showing optical paths of FIG. 2, an axial bundle of rays wa, and a bundle of rays wb at the maximum angle of view, loci of movement (the arrows in the drawing) of the individual lens groups during magnification change, and a point at which the imaging magnification is −1× (the horizontal dashed line in the drawing) are shown.

As shown in FIG. 1, this zoom lens consists of, in order from the object side, a first lens group G1 having a positive refractive power, a second lens group G2 having a negative refractive power, a third lens group G3 having a positive refractive power, a fourth lens group G4 having a positive refractive power, an aperture stop St, and a fifth lens group G5 having a positive refractive power.

When this zoom lens is applied to an imaging apparatus, it is preferred to provide a cover glass, a prism, and various filters, such as an infrared cutoff filter and a low-pass filter, etc., between the optical system and the image plane Sim depending on the configuration of the camera on which the lens is mounted. In the example shown in FIGS. 1 and 2, optical members PP1 to PP3 in the form of plane-parallel plates, which are assumed to represent such elements, are disposed between the lens system and the image plane Sim.

The first lens group G1 and the fifth lens group G5 are fixed relative to the image plane Sim during magnification change. The second lens group G2, the third lens group G3, and the fourth lens group G4 are moved to change distances therebetween during magnification change. The second lens group G2 is moved from the object side toward the image plane side during magnification change from the wide angle end to the telephoto end.

The second lens group G2 includes at least one positive lens and at least four negative lenses including three negative lenses that are disposed consecutively from the most object side. Distributing the negative refractive power of the second lens group G2 among four or more negative lenses in this manner allows suppressing fluctuation of spherical aberration and distortion during magnification change, and this is advantageous for achieving high magnification ratio. This also allows increasing the refractive power of each of the negative lenses and the positive lens(es) while keeping a sufficient refractive power of the second lens group G2, thereby allowing suppressing fluctuation of longitudinal chromatic aberration and lateral chromatic aberration during magnification change when Abbe numbers of the positive lens(es) and the negative lenses are set such that differences therebetween are not large in view of correction of secondary chromatic aberration. Disposing the three negative lenses successively in order from the object side of the second lens group G2 to concentrate the negative refractive power of the second lens group G2 at the object side results in a small angle between the optical axis and the principal ray of the peripheral angle of view entering the subsequent lenses at the wide angle end, and this is advantageous for achieving wide angle of view. This also allows preventing increase of distortion and astigmatism associated with high magnification ratio, and allows correction of astigmatism that tends to occur at the first lens group G1 at the wide angle end.

Further, the second lens group G2 and an L21 negative lens, which is the most object-side lens of the negative lenses of the second lens group G2 satisfy the condition expressions (1) and (2) below. Setting the value of νd21 such that it does not become equal to or smaller than the lower limit of the condition expression (1) allows suppressing fluctuation of primary lateral chromatic aberration and primary longitudinal chromatic aberration during magnification change. Setting the value of νd21 such that it does not become equal to or greater than the upper limit of condition expression (1) allows correcting secondary lateral chromatic aberration that occurs at the first lens group G1 at the wide angle end when secondary longitudinal chromatic aberration at the telephoto end is corrected, thereby allowing correction of secondary longitudinal chromatic aberration at the telephoto end, lateral chromatic aberration at the telephoto end, and secondary lateral chromatic aberration at the wide angle end in a well-balanced manner.

In the case where the value of νd21 is set such that it does not become equal to or smaller than the lower limit of the condition expression (1) and the value of f2/f21 is set such that it does not become equal to or smaller than the lower limit of the condition expression (2), the advantageous effects with respect to the lower limit of the condition expression (1) can be enhanced. Setting the value of f2/f21 such that it does not become equal to or greater than the upper limit of the condition expression (2) allows preventing increase of distortion at the wide angle end.

It should be noted that higher performance can be obtained when the condition expression (1-1) and/or (2-1) below is satisfied.

25<νd21<45 (1),

28<νd21<40 (1-1),

0.31<f2/f21<0.7 (2),

0.36<f2/f21<0.55 (2-1),

where νd21 is an Abbe number with respect to the d-line of the L21 negative lens, f2 is a focal length with respect to the d-line of the second lens group, and f21 is a focal length with respect to the d-line of the L21 negative lens.

In the zoom lens of the disclosure, it is preferred that the condition expression (3) below be satisfied. In the case where the value of νd21 is set such that it does not become equal to or smaller than the lower limit of the condition expression (1) and the value of fw/f21 is set such that it does not become equal to or smaller than the lower limit of the condition expression (3), the advantageous effects with respect to the lower limit of the condition expression (1) can be enhanced. Setting the value of νd21 such that it does not become equal to or smaller than the lower limit of the condition expression (1) and setting the value of fw/f21 such that it does not become equal to or greater than the upper limit of the condition expression (3) allows correcting secondary lateral chromatic aberration that occurs at the first lens group G1 at the wide angle end when secondary longitudinal chromatic aberration at the telephoto end is corrected, thereby allowing correction of secondary longitudinal chromatic aberration at the telephoto end, lateral chromatic aberration at the telephoto end, and secondary lateral chromatic aberration at the wide angle end in a well-balanced manner. It should be noted that higher performance can be obtained when the condition expression (3-1) below is satisfied.

−0.3<fw/f21<−0.105 (3),

−0.2<fw/f21<−0.11 (3-1),

where fw is a focal length with respect to the d-line of the entire system at the wide angle end, and f21 is a focal length with respect to the d-line of the L21 negative lens.

It is preferred that the second lens group G2 consist of, in order from the object side, an L21 negative lens L21, an L22 negative lens L22, a cemented lens formed by, in order from the object side, an L23 negative lens L23 having a biconcave shape and an L24 positive lens L24 that are cemented together, and a cemented lens formed by, in order from the object side, an L25 positive lens L25 having a convex surface toward the image plane side and an L26 negative lens L26 that are cemented together.

This configuration allows achieving wide angle of view while suppressing fluctuation of chromatic aberration associated with high magnification ratio. In particular, distributing the negative refractive power of the second lens group G2 among the four negative lenses L21, L22, L23, and L26 and distributing the positive refractive power of the second lens group G2 between the two positive lenses L24 and L25 allows suppressing fluctuation of aberrations, in particular, distortion and spherical aberration, while maintaining the negative refractive power of the second lens group G2 necessary for achieving high magnification ratio. Further, disposing the three negative lenses L21, L22, and L23 successively in order from the object side results in a small angle between the optical axis and the principal ray of the peripheral angle of view entering the subsequent lenses at the wide angle end, and this is advantageous for achieving wide angle of view. This also allows preventing increase of distortion and astigmatism associated with high magnification ratio, and allows correction of astigmatism that tends to occur at the first lens group G1 at the wide angle end. The cemented surface between the L25 positive lens L25 and the L26 negative lens L26 which is convex toward the image plane side allows suppressing differences of spherical aberration depending on the wavelength while correcting longitudinal chromatic aberration at the telephoto end.

In this case, it is preferred that the condition expression (4) below be satisfied. At the telephoto end, the incident angle of the axial marginal ray on the cemented surface between the L25 positive lens L25 and the L26 negative lens L26 which is convex toward the image plane is smaller than the incident angle of the axial marginal ray on the other cemented surface of the two cemented surfaces in the second lens group G2. Therefore, setting a larger difference between Abbe numbers at this cemented surface, i.e., setting a larger amount of correction of chromatic aberration at this cemented surface allows suppressing the differences of spherical aberration depending on the wavelength at the telephoto end.

L23νd−L24νd<L26νd−L25νd (4),

where L23νd is an Abbe number with respect to the d-line of the L23 negative lens, L24νd is an Abbe number with respect to the d-line of the L24 positive lens, L26νd is an Abbe number with respect to the d-line of the L26 negative lens, and L25νd is an Abbe number with respect to the d-line of the L25 positive lens.

It is preferred that the first lens group G1 consist of, in order from the object side, an L11 negative lens L11, an L12 positive lens L12, an L13 positive lens L13, an L14 positive lens L14, and an L15 positive lens L15 having a meniscus shape with the convex surface toward the object side, and satisfy the condition expressions (5) and (6) below. This configuration of the first lens group G1 allows minimizing increase of the weight. Satisfying the condition expressions (5) and (6) at the same time allows successfully correcting spherical aberration and coma while suppressing chromatic aberration across the entire zoom range. It should be noted that higher performance can be obtained when the condition expression (5-1) and/or (6-1) below is satisfied.

1.75<ndL11 (5),

1.80<ndL11 (5-1),

νdL11<45 (6),

νdL11<40 (6-1),

where ndL11 is a refractive index with respect to the d-line of the L11 negative lens, and νdL11 is an Abbe number with respect to the d-line of the L11 negative lens.

It is preferred that the position of the fourth lens group G4 at the telephoto end be nearer to the object side than the position of the fourth lens group G4 at the wide angle end. This configuration allows the function to effect magnification change to be shared by the fourth lens group G4 and the second lens group G2, and this allows suppressing fluctuation of aberrations during magnification change, which is advantageous for achieving high magnification ratio.

It is preferred that the distance between the second lens group G2 and the third lens group G3 at the telephoto end is narrower than the distance between the second lens group G2 and the third lens group G3 at the wide angle end. This configuration is advantageous for achieving high magnification ratio.

It is preferred that the fifth lens group G5 include at least two negative lenses, and satisfy the condition expression (7) below. Setting the value of LABnd such that it does not become equal to or smaller than the lower limit of the condition expression (7) allows suppressing overcorrection of Petzval sum, which tends to occur when achieving high magnification ratio, and this facilitates correcting astigmatism and correcting field curvature at the same time, which is advantageous for achieving wide angle of view. It should be noted that higher performance can be obtained when the condition expression (7-1) below is satisfied.

1.90<LABnd (7),

1.94<LABnd (7-1),

where LABnd is an average value of a refractive index LAnd with respect to the d-line of an LA negative lens that is the first negative lens from the image plane side of the fifth lens group and a refractive index LBnd with respect to the d-line of an LB negative lens that is the second negative lens from the image plane side of the fifth lens group.

In this case, it is preferred that the condition expression (8) below be satisfied. Setting the value of LAnd-LCnd such that it does not become equal to or smaller than the lower limit of the condition expression (8) allows enhancing the advantageous effects with respect to condition expression (7), thereby successfully suppressing Petzval sum, and this is advantageous for achieving wide angle of view. It should be noted that higher performance can be obtained when the condition expression (8-1) below is satisfied.

0.42<LAnd−LCnd (8),

0.45<LAnd−LCnd (8-1),

where LAnd is a refractive index with respect to the d-line of the LA negative lens that is the first negative lens from the image plane side of the fifth lens group, and LCnd is a refractive index with respect to the d-line of an LC positive lens that is the first positive lens from the image plane side of the fifth lens group.

It is preferred that the fifth lens group G5 include at least two negative lenses, and satisfy the condition expression (9) below. Setting the value of LABνd such that it does not become equal to or smaller than the lower limit of the condition expression (9) is advantageous for correction of lateral chromatic aberration. Setting the value of LABνd such that it does not become equal to or greater than the upper limit of condition expression (9) is advantageous for correction of longitudinal chromatic aberration. It should be noted that higher performance can be obtained when the condition expression (9-1) below is satisfied.

25<LABνd<40 (9),

30<LABνd<36 (9-1),

where LABνd is an average value of an Abbe number LAνd with respect to the d-line of the LA negative lens that is the first negative lens from the image plane side of the fifth lens group and an Abbe number LBνd with respect to the d-line of the LB negative lens that is the second negative lens from the image plane side of the fifth lens group.

It is preferred that, during magnification change from the wide angle end to the telephoto end, each of a third-fourth combined lens group, which is formed by the third lens group G3 and the fourth lens group G4, and the second lens group G2 simultaneously passes through a point at which the imaging magnification of the lens group is −1×. This configuration allows achieving a compact zoom lens having high magnification ratio with successfully suppressed fluctuation of aberrations.

It is preferred that the distance between the third lens group G3 and the fourth lens group G4 is the greatest at a point on the wide angle side of the point at which the imaging magnification of the third-fourth combined lens group, which is formed by the third lens group G3 and the fourth lens group G4, is −1×. On the wide angle side of the point at which the imaging magnification of the third-fourth combined lens group is −1×, the ray height at the most object-side L11 lens L11 becomes high. Therefore, the configuration where the distance between the third lens group G3 and the fourth lens group G4 is the greatest in this range is advantageous for achieving wide angle of view.

It is preferred that the third-fourth combined lens group, which is formed by the third lens group G3 and the fourth lens group G4, include at least one negative lens, and satisfy the condition expression (10) below. Setting the value of νdG34n such that it does not become equal to or smaller than the lower limit of the condition expression (10) allows successfully correcting chromatic aberration at the fourth lens group G4. Setting the value of νdG34n such that it does not become equal to or greater than the upper limit of condition expression (10) allows successfully correcting spherical aberration and coma. That is, satisfying condition expression (10) allows successful correction of spherical aberration and coma during magnification change while successfully correcting longitudinal chromatic aberration that occurs at the telephoto side during magnification change, and this allows achieving a high magnification zoom lens with successfully suppressed fluctuation of aberrations across the entire zoom range. It should be noted that higher performance can be obtained when the condition expression (10-1) below is satisfied.

29<νdG34n<37 (10),

29.5<νdG34n<36 (10-1),

where νdG34n is an average value of Abbe numbers with respect to the d-line of all negative lenses of the third-fourth combined lens group.

In the example shown in FIGS. 1 and 2, the optical members PP1 to PP3 are disposed between the lens system and the image plane Sim. However, in place of disposing the various filters, such as a low-pass filter and a filter that cuts off a specific wavelength range, between the lens system and the image plane Sim, the various filters may be disposed between the lenses, or coatings having the same functions as the various filters may be applied to the lens surfaces of some of the lenses.

Next, numerical examples of the zoom lens of the disclosure are described.

First, a zoom lens of Example 1 is described. FIG. 1 is a sectional view illustrating the lens configuration of the zoom lens of Example 1. FIG. 2 is a diagram showing optical paths through the zoom lens of Example 1. It should be noted that, in FIGS. 1 and 2, and FIGS. 3 to 8 corresponding to Examples 2 to 4, which will be described later, the left side is the object side and the right side is the image plane side. The aperture stop St shown in the drawings does not necessarily represent the size and the shape thereof, but represents the position thereof along the optical axis Z. In the diagrams showing optical paths, an axial bundle of rays wa, and a bundle of rays wb at the maximum angle of view, loci of movement (the arrows in the drawing) of the individual lens groups during magnification change, and a point at which the imaging magnification is −1× (the horizontal dashed line in the drawing) are shown.

In the zoom lens of Example 1, the first lens group G1 is formed by five lenses, i.e., lenses L11 to L15, the second lens group G2 is formed by six lenses, i.e., lenses L21 to L26, the third lens group G3 is formed by one lens L31, the fourth lens group G4 is formed by five lenses, i.e., lenses L41 to L45, and the fifth lens group G5 is formed by thirteen lenses, i.e., lenses L51 to L63.

Table 1 shows basic lens data of the zoom lens of Example 1, Table 2 shows data about specifications of the zoom lens, Table 3 shows data about variable surface distances of the zoom lens, and Table 4 shows data about aspheric coefficients of the zoom lens. In the following description, meanings of symbols used in the tables are explained with respect to Example 1 as an example. The same explanations basically apply to those with respect to Examples 2 to 4.

In the lens data shown in Table 1, each value in the column of “Surface No.” represents a surface number, where the object-side surface of the most object-side element is the 1st surface and the number is sequentially increased toward the image plane side, each value in the column of “Radius of Curvature” represents the radius of curvature of the corresponding surface, and each value in the column of “Surface Distance” represents the distance along the optical axis Z between the corresponding surface and the next surface. Each value in the column of “nd” represents the refractive index with respect to the d-line (the wavelength of 587.6 nm) of the corresponding optical element, each value in the column of “νd” represents the Abbe number with respect to the d-line (the wavelength of 587.6 nm) of the corresponding optical element, and each value in the column of “θg,f” represents the partial dispersion ratio of the corresponding optical element.

It should be noted that the partial dispersion ratio θg,f is expressed by the formula below:

θg,f=(Ng−NF)/(NF−NC),

where Ng is a refractive index with respect to the g-line, NF is a refractive index with respect to F-line, and NC is a refractive index with respect to the C-line.

The sign with respect to the radius of curvature is provided such that a positive radius of curvature indicates a surface shape that is convex toward the object side, and a negative radius of curvature indicates a surface shape that is convex toward the image plane side. The basic lens data also includes data about the aperture stop St and the optical members PP1 to PP3, and the surface number and the text “(stop)” are shown at the position in the column of the surface number corresponding to the aperture stop St. In the lens data shown in Table 1, each surface distance that is variable during magnification change is represented by the symbol “DD[surface number]”. The numerical value corresponding to each DD[surface number] is shown in Table 3.

The data about specifications shown in Table 2 show values of zoom magnification, focal length f′, back focus Bf′, F-number FNo., and full angle of view 2ω.

With respect to the basic lens data, the data about specifications, and the data about variable surface distances, the unit of angle is degrees, and the unit of length is millimeters; however, any other suitable units may be used since optical systems are usable when they are proportionally enlarged or reduced.

In the lens data shown in Table 1, the symbol “*” is added to the surface number of each aspheric surface, and the numerical value of the paraxial radius of curvature is shown as the radius of curvature of each aspheric surface. In the data about aspheric coefficients shown in Table 4, the surface number of each aspheric surface and aspheric coefficients about each aspheric surface are shown. The aspheric coefficients are values of the coefficients KA and Am (where m=3, . . . , 20) in the formula of aspheric surface shown below:

Zd=C·h²/{1+(1−KA·C²·h²)^{1/2}}ΣAm·h^{m},

where Zd is a depth of the aspheric surface (a length of a perpendicular line from a point with a height h on the aspheric surface to a plane tangent to the apex of the aspheric surface and perpendicular to the optical axis), h is the height (a distance from the optical axis), C is a reciprocal of the paraxial radius of curvature, and KA and Am are aspheric coefficients (where m=3, . . . , 20).

TABLE 1
Example 1 - Lens Data

| Surface | Radius of | Surface | | | |
|---|---|---|---|---|---|
| No. | Curvature | Distance | nd | νd | θg, f |
| 1 | 2149.2163 | 4.4000 | 1.83400 | 37.16 | 0.57759 |
| 2 | 364.4008 | 1.8100 | | | |
| 3 | 357.1559 | 24.5800 | 1.43387 | 95.18 | 0.53733 |
| 4 | −629.0299 | 32.8500 | | | |
| 5 | 363.8700 | 15.6200 | 1.43387 | 95.18 | 0.53733 |
| 6 | ∞ | 0.1200 | | | |
| 7 | 310.1672 | 17.8400 | 1.43387 | 95.18 | 0.53733 |
| 8 | ∞ | 2.9000 | | | |
| 9 | 173.0993 | 14.6700 | 1.43875 | 94.94 | 0.53433 |
| 10 | 310.0848 | DD[10] | | | |
| *11 | 109963.7968 | 2.8000 | 1.90366 | 31.31 | 0.59481 |
| 12 | 56.5266 | 8.6300 | | | |
| 13 | −84.6070 | 1.6000 | 2.00100 | 29.13 | 0.59952 |
| 14 | 321.4052 | 6.6700 | | | |
| 15 | −62.2824 | 1.6000 | 1.95375 | 32.32 | 0.59015 |
| 16 | 115.4560 | 6.9400 | 1.89286 | 20.36 | 0.63944 |
| 17 | −73.9497 | 0.1200 | | | |
| 18 | 962.3821 | 7.7100 | 1.80518 | 25.43 | 0.61027 |
| 19 | −51.3780 | 1.6200 | 1.80400 | 46.58 | 0.55730 |
| 20 | 2303.8825 | DD[20] | | | |
| 21 | 170.3657 | 9.7800 | 1.49700 | 81.54 | 0.53748 |
| *22 | −209.1383 | DD[22] | | | |
| 23 | 137.4359 | 11.9100 | 1.43700 | 95.10 | 0.53364 |
| 24 | −175.8090 | 2.0000 | 1.59270 | 35.31 | 0.59336 |
| 25 | −597.2019 | 0.2500 | | | |
| *26 | 188.3526 | 9.3100 | 1.43700 | 95.10 | 0.53364 |
| 27 | −195.4929 | 0.1200 | | | |
| 28 | 247.3158 | 2.0000 | 1.80000 | 29.84 | 0.60178 |
| 29 | 94.0850 | 12.0500 | 1.43700 | 95.10 | 0.53364 |
| 30 | −217.6314 | DD[30] | | | |
| 31(stop) | ∞ | 5.0700 | | | |
| 32 | −188.3440 | 1.4000 | 1.77250 | 49.60 | 0.55212 |
| 33 | 62.0923 | 0.1200 | | | |
| 34 | 43.4903 | 4.5500 | 1.80518 | 25.42 | 0.61616 |
| 35 | 151.4362 | 2.0300 | | | |
| 36 | −188.3403 | 1.4000 | 1.48749 | 70.24 | 0.53007 |
| 37 | 72.1812 | 9.2600 | | | |
| 38 | −50.3918 | 3.2500 | 1.80440 | 39.59 | 0.57297 |
| 39 | 63.9801 | 8.1300 | 1.80518 | 25.43 | 0.61027 |
| 40 | −46.8126 | 0.3400 | | | |
| 41 | −50.8827 | 1.6600 | 1.95375 | 32.32 | 0.59015 |
| 42 | 56.9580 | 7.3800 | 1.72916 | 54.68 | 0.54451 |
| 43 | −73.6910 | 0.1200 | | | |
| 44 | 215.7126 | 10.9800 | 1.73800 | 32.26 | 0.58995 |
| 45 | −215.7126 | 8.8100 | | | |
| 46 | 182.7540 | 17.0600 | 1.67003 | 47.23 | 0.56276 |
| 47 | −103.9363 | 0.1200 | | | |
| 48 | 148.7010 | 2.9000 | 1.95375 | 32.32 | 0.59015 |
| 49 | 44.8210 | 0.8500 | | | |
| 50 | 44.9406 | 10.1300 | 1.51633 | 64.14 | 0.53531 |
| 51 | −64.7286 | 0.1200 | | | |
| 52 | 65.6410 | 5.1900 | 1.48749 | 70.24 | 0.53007 |
| 53 | −65.6410 | 1.8500 | 1.95375 | 32.32 | 0.59015 |
| 54 | ∞ | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 17.3299 | | | |

TABLE 2
Example 1 - Specifications (d-line)

| | Wide Angle End | Middle | Telephoto End |
|---|---|---|---|
| Zoom Magnification | 1.0 | 48.0 | 77.0 |
| f′ | 9.30 | 446.26 | 715.88 |
| Bf′ | 47.46 | 47.46 | 47.46 |
| FNo. | 1.76 | 2.27 | 3.64 |
| 2ω[°] | 65.0 | 1.4 | 0.8 |

TABLE 3
Example 1 - Distances with respect to Zoom

| | Wide Angle End | Middle | Telephoto End |
|---|---|---|---|
| DD[10] | 2.8554 | 186.6407 | 191.1526 |
| DD[20] | 291.2076 | 26.4986 | 3.9764 |
| DD[22] | 1.4039 | 6.7033 | 1.9940 |
| DD[30] | 3.1233 | 78.7475 | 101.4671 |

TABLE 4
Example 1 - Aspheric Coefficients

| Surface | | | |
|---|---|---|---|
| No. | 11 | 22 | 26 |
| KA | 1.0000000E+00 | 1.0000000E+00 | 1.0000000E+00 |
| A3 | −1.8505954E−21 | −7.1721817E−22 | 6.6507804E−22 |
| A4 | 4.0660287E−07 | 1.6421968E−07 | −2.8081272E−07 |
| A5 | −6.4796240E−09 | −5.6511999E−09 | −8.0962001E−09 |
| A6 | 8.4021729E−10 | 1.7414539E−10 | 2.8172499E−10 |
| A7 | −4.5016908E−11 | 7.4176985E−13 | −1.6052722E−12 |
| A8 | 4.3463314E−13 | −9.7299399E−14 | −1.0541094E−13 |
| A9 | 3.5919548E−14 | 1.1281878E−15 | 2.1399424E−15 |
| A10 | −8.9257498E−16 | −4.4848875E−19 | −1.0917621E−17 |

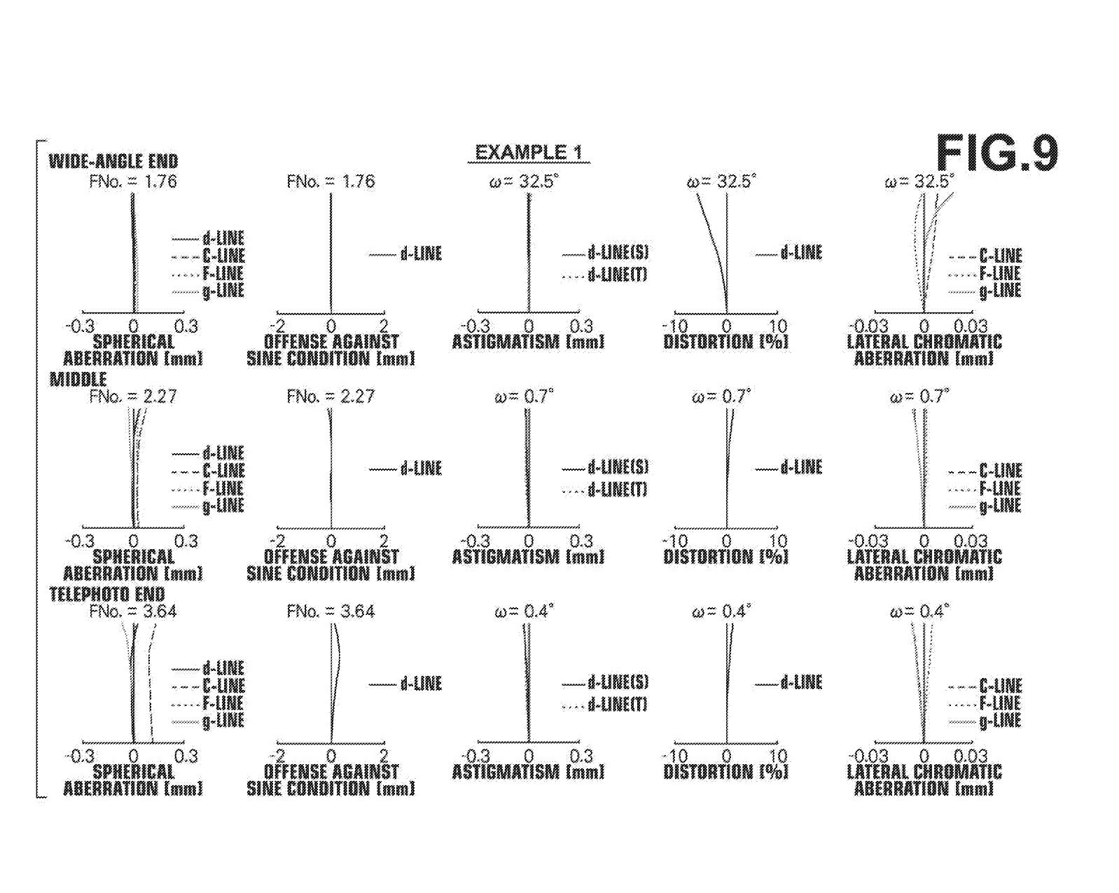

FIG. 9 shows aberration diagrams of the zoom lens of Example 1. The aberration diagrams shown at the top of FIG. 9 are those of spherical aberration, offense against the sine condition, astigmatism, distortion, and lateral chromatic aberration at the wide-angle end in this order from the left side. The aberration diagrams shown at the middle of FIG. 9 are those of spherical aberration, offense against the sine condition, astigmatism, distortion, and lateral chromatic aberration at the middle position in this order from the left side. The aberration diagrams shown at the bottom of FIG. 9 are those of spherical aberration, offense against the sine condition, astigmatism, distortion, and lateral chromatic aberration at the telephoto end in this order from the left side. These aberration diagrams show aberrations when the object distance is infinity. The aberration diagrams of spherical aberration, offense against the sine condition, astigmatism, and distortion show those with respect to the d-line (the wavelength of 587.6 nm), which is used as a reference wavelength. The aberration diagrams of spherical aberration show those with respect to the d-line (the wavelength of 587.6 nm), the C-line (the wavelength of 656.3 nm), the F-line (the wavelength of 486.1 nm), and the g-line (the wavelength of 435.8 nm) in the solid line, the long dashed line, the short dashed line, and the gray solid line, respectively. The aberration diagrams of astigmatism show those in the sagittal direction and the tangential direction in the solid line, and the short dashed line, respectively. The aberration diagrams of lateral chromatic aberration show those with respect to the C-line (the wavelength of 656.3 nm), the F-line (the wavelength of 486.1 nm), and the g-line (the wavelength of 435.8 nm) in the long dashed line, the short dashed line, and the gray solid line, respectively. The symbol “FNo.” in the aberration diagrams of spherical aberration and offense against the sine condition means “f-number”, and the symbol “ω” in the other aberration diagrams means “half angle of view”.

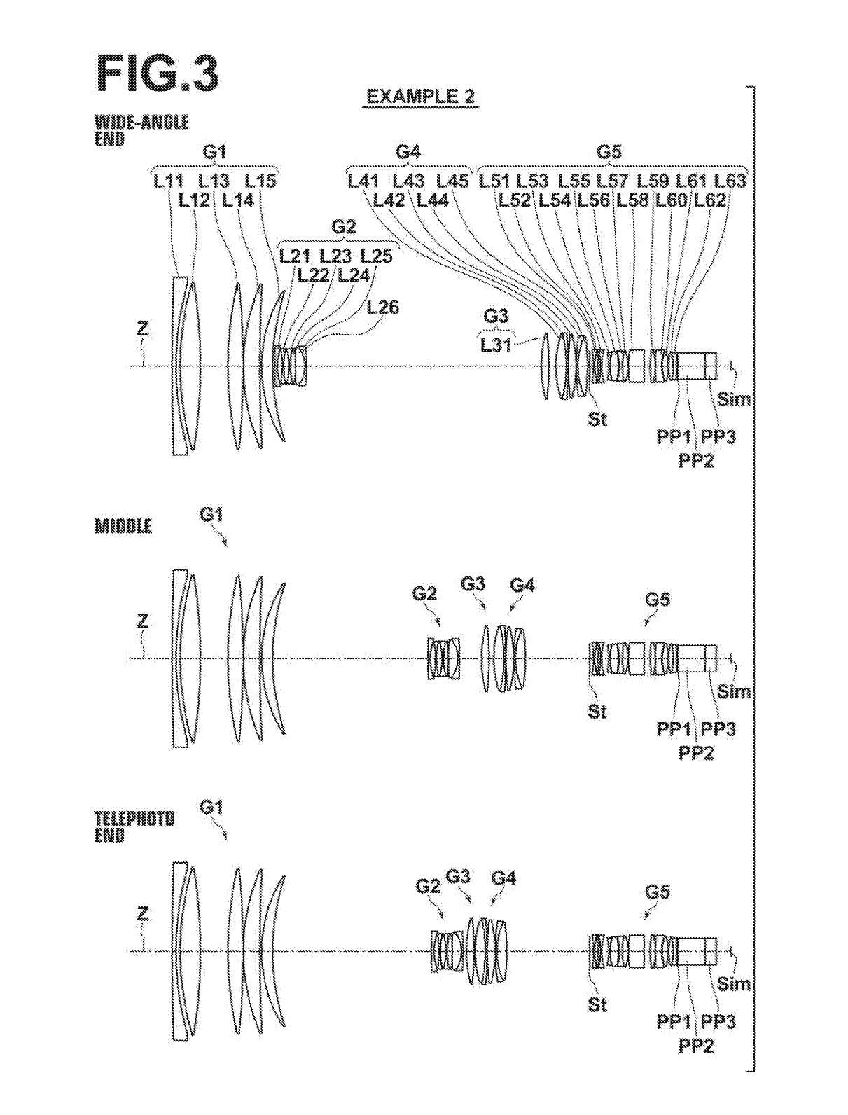

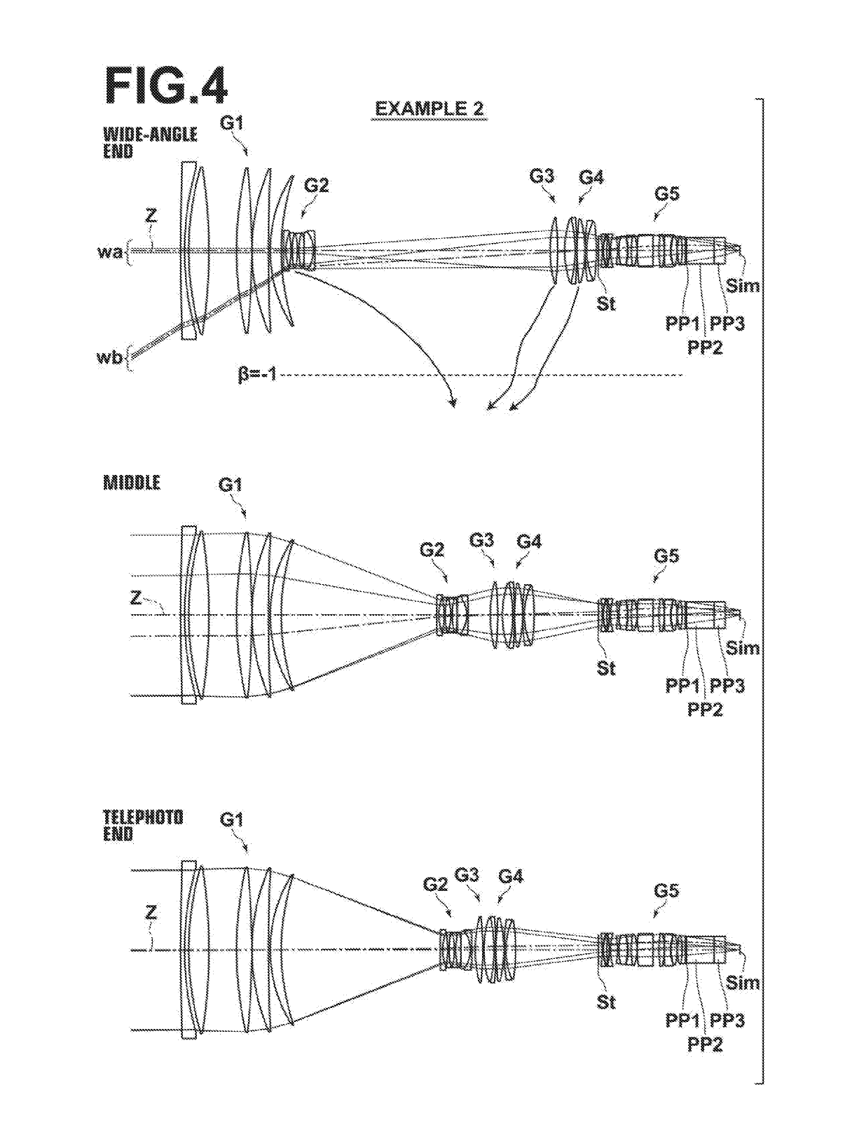

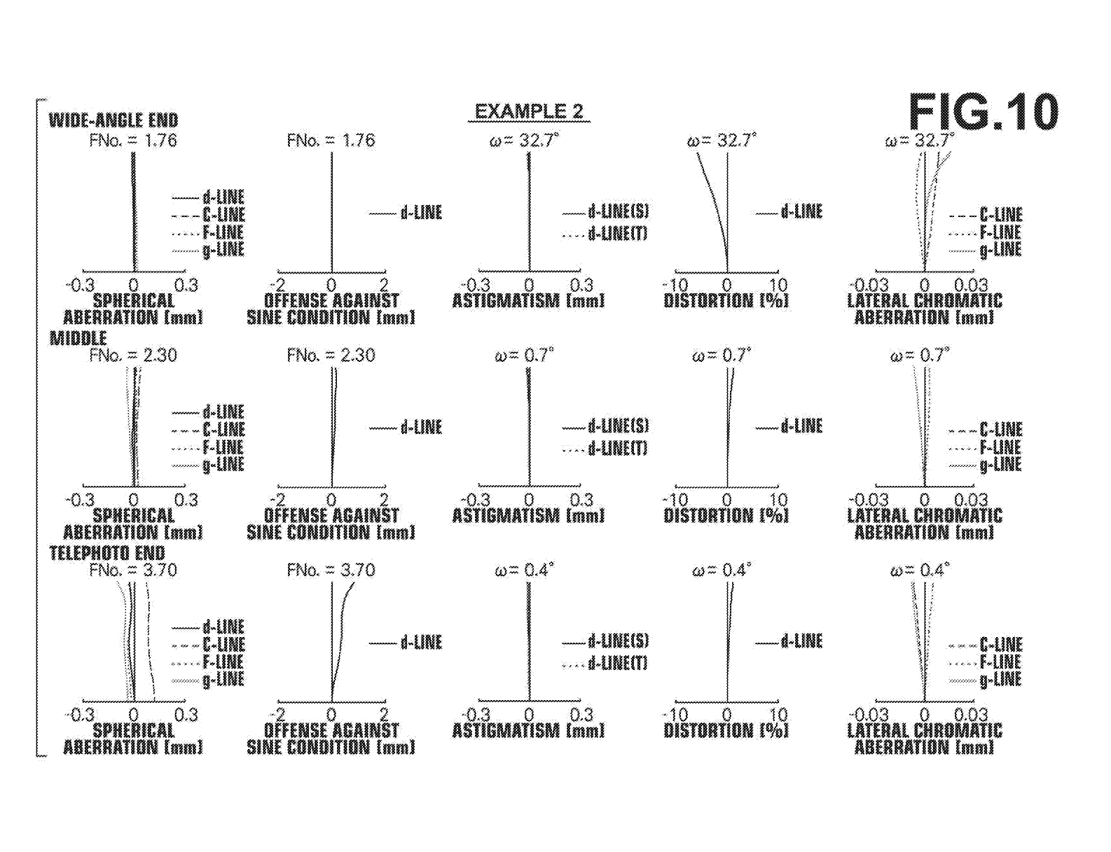

Next, a zoom lens of Example 2 is described. FIG. 3 is a sectional view illustrating the lens configuration of the zoom lens of Example 2, and FIG. 4 is a diagram showing optical paths through the zoom lens. The zoom lens of Example 2 is formed by the same number of lenses as the zoom lens of Example 1. Table 5 shows basic lens data of the zoom lens of Example 2, Table 6 shows data about specifications of the zoom lens, Table 7 shows data about variable surface distances of the zoom lens, Table 8 shows data about aspheric coefficients of the zoom lens, and FIG. 10 shows aberration diagrams of the zoom lens.

TABLE 5
Example 2 - Lens Data

| Surface | Radius of | Surface | | | |
|---|---|---|---|---|---|
| No. | Curvature | Distance | nd | νd | θg, f |
| 1 | 3475.3702 | 4.4000 | 1.83400 | 37.16 | 0.57759 |
| 2 | 372.4955 | 5.0357 | | | |
| 3 | 366.9209 | 23.9056 | 1.43387 | 95.18 | 0.53733 |
| 4 | −682.9236 | 32.9837 | | | |
| 5 | 454.1605 | 18.2207 | 1.43387 | 95.18 | 0.53733 |
| 6 | −986.9790 | 0.1100 | | | |
| 7 | 253.2817 | 19.6205 | 1.43387 | 95.18 | 0.53733 |
| 8 | 1947.2332 | 2.0966 | | | |
| 9 | 173.1049 | 13.3055 | 1.43875 | 94.94 | 0.53433 |
| 10 | 292.3182 | DD[10] | | | |
| *11 | 841.9448 | 2.8000 | 1.95375 | 32.32 | 0.59015 |
| 12 | 64.1193 | 5.9910 | | | |
| 13 | −139.9177 | 1.7000 | 2.00100 | 29.13 | 0.59952 |
| 14 | 103.9852 | 6.2479 | | | |
| 15 | −79.6795 | 1.7000 | 1.95375 | 32.32 | 0.59015 |
| 16 | 86.5057 | 6.0539 | 1.84666 | 23.83 | 0.61603 |
| 17 | −153.6438 | 0.1200 | | | |
| 18 | 487.2966 | 11.2129 | 1.80809 | 22.76 | 0.63073 |
| 19 | −38.0425 | 1.7000 | 1.81600 | 46.62 | 0.55682 |
| 20 | −403.3473 | DD[20] | | | |
| 21 | 152.9719 | 9.0813 | 1.59282 | 68.62 | 0.54414 |
| *22 | −317.0888 | DD[22] | | | |
| 23 | 126.9262 | 12.2707 | 1.43700 | 95.10 | 0.53364 |
| 24 | −172.5904 | 2.0000 | 1.59270 | 35.31 | 0.59336 |
| 25 | −585.3741 | 0.1200 | | | |
| *26 | 225.1390 | 9.6209 | 1.43700 | 95.10 | 0.53364 |
| 27 | −151.7222 | 0.1200 | | | |
| 28 | 263.3903 | 2.0000 | 1.80000 | 29.84 | 0.60178 |
| 29 | 88.7553 | 11.7320 | 1.43700 | 95.10 | 0.53364 |
| 30 | −232.3846 | DD[30] | | | |
| 31(stop) | ∞ | 4.1987 | | | |
| 32 | −163.6964 | 1.5000 | 1.78800 | 47.37 | 0.55598 |
| 33 | 66.6579 | 0.1200 | | | |
| 34 | 46.2167 | 4.0850 | 1.76182 | 26.52 | 0.61361 |
| 35 | 152.4046 | 2.8557 | | | |
| 36 | −98.8029 | 1.5000 | 1.48749 | 70.24 | 0.53007 |
| 37 | 67.8883 | 8.2120 | | | |
| 38 | −103.2169 | 1.8000 | 1.83481 | 42.72 | 0.56486 |
| 39 | 62.9851 | 10.1794 | 1.84666 | 23.83 | 0.61603 |
| 40 | −74.4274 | 0.8479 | | | |
| 41 | −63.4207 | 3.4958 | 1.95375 | 32.32 | 0.59015 |
| 42 | 101.4326 | 7.1124 | 1.60311 | 60.64 | 0.54148 |
| 43 | −57.8040 | 0.1200 | | | |
| 44 | 127.8051 | 19.0888 | 1.61772 | 49.81 | 0.56035 |
| 45 | −5769.3694 | 7.1792 | | | |
| 46 | 244.7704 | 5.7290 | 1.58913 | 61.13 | 0.54067 |
| 47 | −108.1583 | 0.1200 | | | |
| 48 | 234.3868 | 7.4062 | 1.95375 | 32.32 | 0.59015 |
| 49 | 50.8661 | 0.7019 | | | |
| 50 | 51.8722 | 7.3813 | 1.58913 | 61.13 | 0.54067 |
| 51 | −74.1423 | 0.1500 | | | |
| 52 | 64.9784 | 5.7488 | 1.48749 | 70.24 | 0.53007 |
| 53 | −92.6312 | 3.8115 | 1.95375 | 32.32 | 0.59015 |
| 54 | −6201.4507 | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 17.5370 | | | |

TABLE 6
Example 2 - Specifications (d-line)

| | Wide Angle End | Middle | Telephoto End |
|---|---|---|---|
| Zoom Magnification | 1.0 | 48.0 | 77.0 |
| f′ | 9.27 | 444.91 | 713.71 |
| Bf′ | 47.67 | 47.67 | 47.67 |
| FNo. | 1.76 | 2.30 | 3.70 |
| 2ω[°] | 65.4 | 1.4 | 0.8 |

TABLE 7
Example 2 - Distances with respect to Zoom

| | Wide Angle End | Middle | Telephoto End |
|---|---|---|---|
| DD[10] | 2.5512 | 185.1434 | 189.5366 |
| DD[20] | 280.2287 | 26.2040 | 3.9658 |
| DD[22] | 8.3473 | 5.5415 | 1.2476 |
| DD[30] | 2.3437 | 76.5819 | 98.7208 |

TABLE 8
Example 2 - Aspheric Coefficients

| Surface | | | |
|---|---|---|---|
| No. | 11 | 22 | 26 |
| KA | 1.0000000E+00 | 1.0000000E+00 | 1.0000000E+00 |
| A4 | 2.7395225E−07 | 1.1987876E−07 | −4.8883780E−07 |
| A6 | −4.8949478E−11 | 2.4237606E−11 | 2.3182674E−11 |
| A8 | 1.8491556E−13 | −2.9894229E−15 | −3.2052197E−15 |
| A10 | −1.9679971E−16 | −3.3833557E−19 | 9.7256769E−20 |

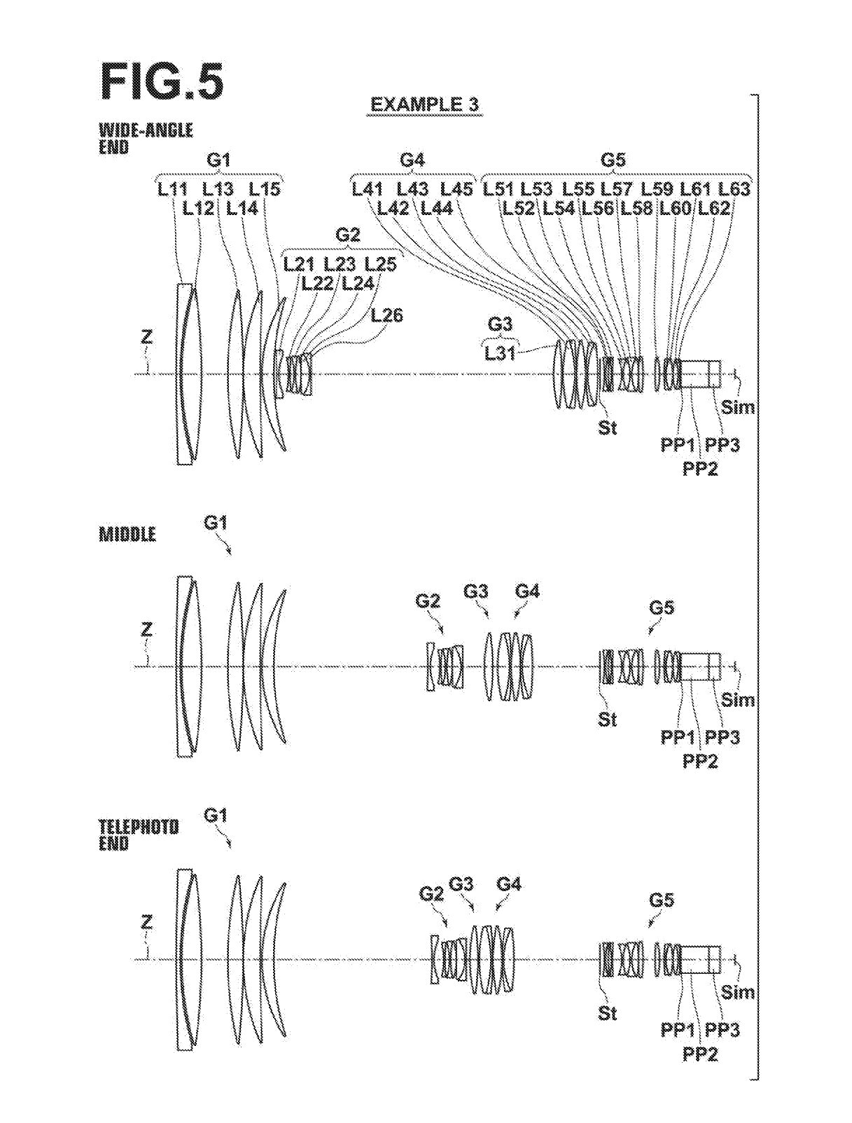

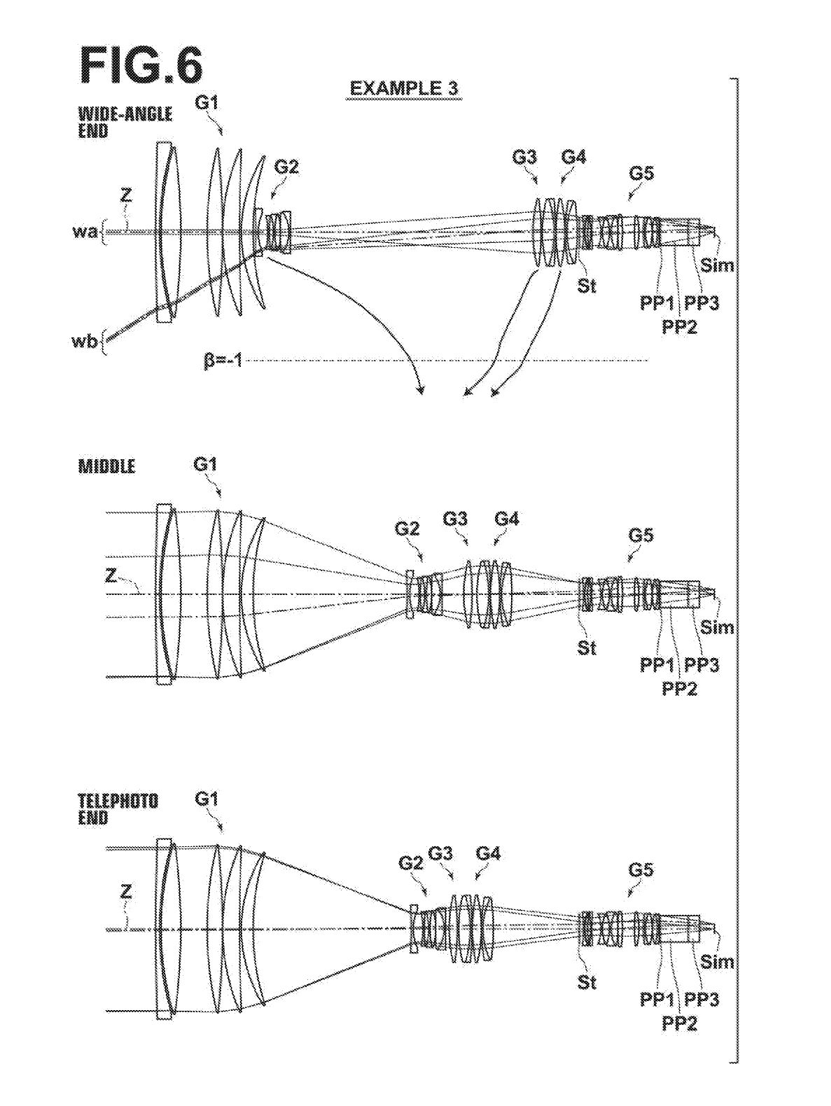

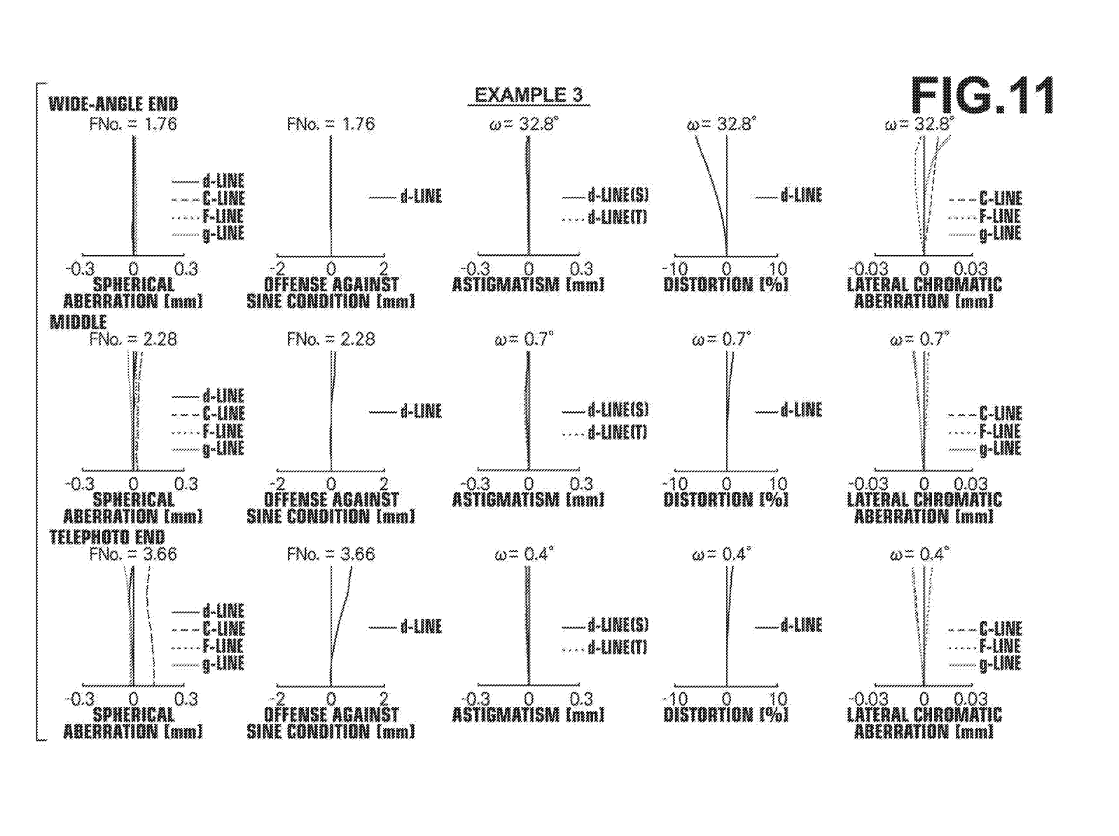

Next, a zoom lens of Example 3 is described. FIG. 5 is a sectional view illustrating the lens configuration of the zoom lens of Example 3, and FIG. 6 is a diagram showing optical paths through the zoom lens. The zoom lens of Example 3 is formed by the same number of lenses as the zoom lens of Example 1. Table 9 shows basic lens data of the zoom lens of Example 3, Table 10 shows data about specifications of the zoom lens, Table 11 shows data about variable surface distances of the zoom lens, Table 12 shows data about aspheric coefficients of the zoom lens, and FIG. 11 shows aberration diagrams of the zoom lens.

TABLE 9
Example 3 - Lens Data

| Surface | Radius of | Surface | | | |
|---|---|---|---|---|---|
| No. | Curvature | Distance | nd | νd | θg, f |
| 1 | 3055.3747 | 4.4000 | 1.83400 | 37.16 | 0.57759 |
| 2 | 372.1635 | 1.9397 | | | |
| 3 | 366.5958 | 22.9318 | 1.43387 | 95.18 | 0.53733 |
| 4 | −745.5153 | 30.9741 | | | |
| 5 | 447.2910 | 17.8731 | 1.43387 | 95.18 | 0.53733 |
| 6 | −1022.1176 | 0.1202 | | | |
| 7 | 250.7002 | 20.0594 | 1.43387 | 95.18 | 0.53733 |
| 8 | 2497.1844 | 2.0893 | | | |
| 9 | 173.5560 | 13.5554 | 1.43875 | 94.94 | 0.53433 |
| 10 | 296.5606 | DD[10] | | | |
| *11 | −536.2036 | 2.8000 | 1.90366 | 31.31 | 0.59481 |
| 12 | 59.0403 | 11.2534 | | | |
| 13 | −94.9158 | 1.7000 | 2.00100 | 29.13 | 0.59952 |
| 14 | 266.5653 | 4.8654 | | | |
| 15 | −73.3496 | 1.7000 | 1.95375 | 32.32 | 0.59015 |
| 16 | 114.5658 | 6.3833 | 1.89286 | 20.36 | 0.63944 |
| 17 | −87.7169 | 0.1202 | | | |
| 18 | 660.4559 | 10.0644 | 1.80518 | 25.43 | 0.61027 |
| 19 | −42.5900 | 1.7000 | 1.81600 | 46.62 | 0.55682 |
| 20 | 2697.8154 | DD[20] | | | |
| 21 | 163.2078 | 9.6780 | 1.53775 | 74.70 | 0.53936 |
| *22 | −262.8890 | DD[22] | | | |
| 23 | 161.2674 | 13.7150 | 1.43700 | 95.10 | 0.53364 |
| 24 | −135.7995 | 2.0000 | 1.59270 | 35.31 | 0.59336 |
| 25 | −425.7431 | 0.2500 | | | |
| *26 | 165.9002 | 10.7003 | 1.43700 | 95.10 | 0.53364 |
| 27 | −172.4386 | 0.1734 | | | |
| 28 | 209.1264 | 2.0000 | 1.80000 | 29.84 | 0.60178 |
| 29 | 88.7369 | 11.9532 | 1.43700 | 95.10 | 0.53364 |
| 30 | −285.7611 | DD[30] | | | |
| 31(stop) | ∞ | 4.8788 | | | |
| 32 | −183.6883 | 1.5000 | 1.72916 | 54.68 | 0.54451 |
| 33 | 65.0566 | 0.1200 | | | |
| 34 | 46.1588 | 3.1785 | 1.89286 | 20.36 | 0.63944 |
| 35 | 74.9110 | 3.4315 | | | |
| 36 | −155.5064 | 1.5000 | 1.48749 | 70.24 | 0.53007 |
| 37 | 286.4381 | 10.8498 | | | |
| 38 | −46.9919 | 1.8000 | 1.95375 | 32.32 | 0.59015 |
| 39 | 54.2501 | 7.9488 | 1.84666 | 23.83 | 0.61603 |
| 40 | −45.8449 | 0.2577 | | | |
| 41 | −49.2346 | 1.8305 | 1.80100 | 34.97 | 0.58642 |
| 42 | 45.4781 | 8.0001 | 1.80400 | 46.58 | 0.55730 |
| 43 | −89.8875 | 0.1849 | | | |
| 44 | 377.4389 | 4.9915 | 1.57135 | 52.95 | 0.55544 |
| 45 | −154.4243 | 14.2327 | | | |
| 46 | 186.3239 | 4.9508 | 1.58267 | 46.42 | 0.56716 |
| 47 | −95.3723 | 5.4549 | | | |
| 48 | 144.8648 | 1.8002 | 1.95375 | 32.32 | 0.59015 |
| 49 | 45.1508 | 0.3951 | | | |
| 50 | 44.2996 | 8.0066 | 1.51633 | 64.14 | 0.53531 |
| 51 | −70.4722 | 0.1425 | | | |
| 52 | 65.0540 | 6.2761 | 1.48749 | 70.24 | 0.53007 |
| 53 | −59.8318 | 1.8002 | 1.95375 | 32.32 | 0.59015 |
| 54 | −463.5944 | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 17.3431 | | | |

TABLE 10
Example 3 - Specifications (d-line)

| | Wide Angle End | Middle | Telephone End |
|---|---|---|---|
| Zoom Magnification | 1.0 | 48.0 | 77.0 |
| f′ | 9.23 | 443.00 | 710.64 |
| Bf′ | 47.47 | 47.47 | 47.47 |
| FNo. | 1.76 | 2.28 | 3.66 |
| 2ω[°] | 65.6 | 1.4 | 0.8 |

TABLE 11
Example 3 - Distances with respect to Zoom

| | Wide Angle End | Middle | Telephoto End |
|---|---|---|---|
| DD[10] | 3.4238 | 181.0344 | 185.5983 |
| DD[20] | 284.5381 | 25.8471 | 3.9765 |
| DD[22] | 1.2485 | 5.8275 | 1.4969 |
| DD[30] | 2.6912 | 79.1928 | 100.8300 |

TABLE 12
Example 3 - Aspheric Coefficients

| Surface | | | |
|---|---|---|---|
| No. | 11 | 22 | 26 |
| KA | 1.0000000E+00 | 1.0000000E+00 | 1.0000000E+00 |
| A3 | −1.8734223E−21 | −9.4994419E−23 | −1.9744504E−22 |
| A4 | 4.0377651E−07 | 2.5885178E−08 | −3.7276810E−07 |
| A5 | 2.8838804E−08 | 8.1208148E−09 | −7.1416960E−09 |
| A6 | −2.3778998E−09 | −4.4404402E−10 | 6.1323910E−10 |
| A7 | −1.3752036E−10 | −1.1642324E−11 | −4.5003167E−12 |
| A8 | 3.3235604E−11 | 2.2808889E−12 | −1.8306327E−12 |
| A9 | −1.1806499E−12 | −3.8082037E−14 | 7.2409382E−14 |
| A10 | −1.1119723E−13 | −4.3094590E−15 | 1.7877810E−15 |
| A11 | 8.8174734E−15 | 1.5931457E−16 | −1.4970490E−16 |
| A12 | 9.1414991E−17 | 3.2617744E−18 | 4.0269046E−19 |
| A13 | −2.4438511E−17 | −2.2129774E−19 | 1.3563698E−19 |
| A14 | 2.8333842E−19 | −9.8414232E−23 | −1.9299794E−21 |
| A15 | 3.4151692E−20 | 1.4709791E−22 | −5.7156780E−23 |
| A16 | −7.6652516E−22 | −1.2247393E−24 | 1.3194211E−24 |
| A17 | −2.3926906E−23 | −4.6409036E−26 | 8.4439905E−27 |
| A18 | 7.0330122E−25 | 6.1748066E−28 | −3.3787964E−28 |
| A19 | 6.6810099E−27 | 5.3374486E−30 | 3.6923088E−31 |
| A20 | −2.3184109E−28 | −8.8908536E−32 | 2.2335912E−32 |

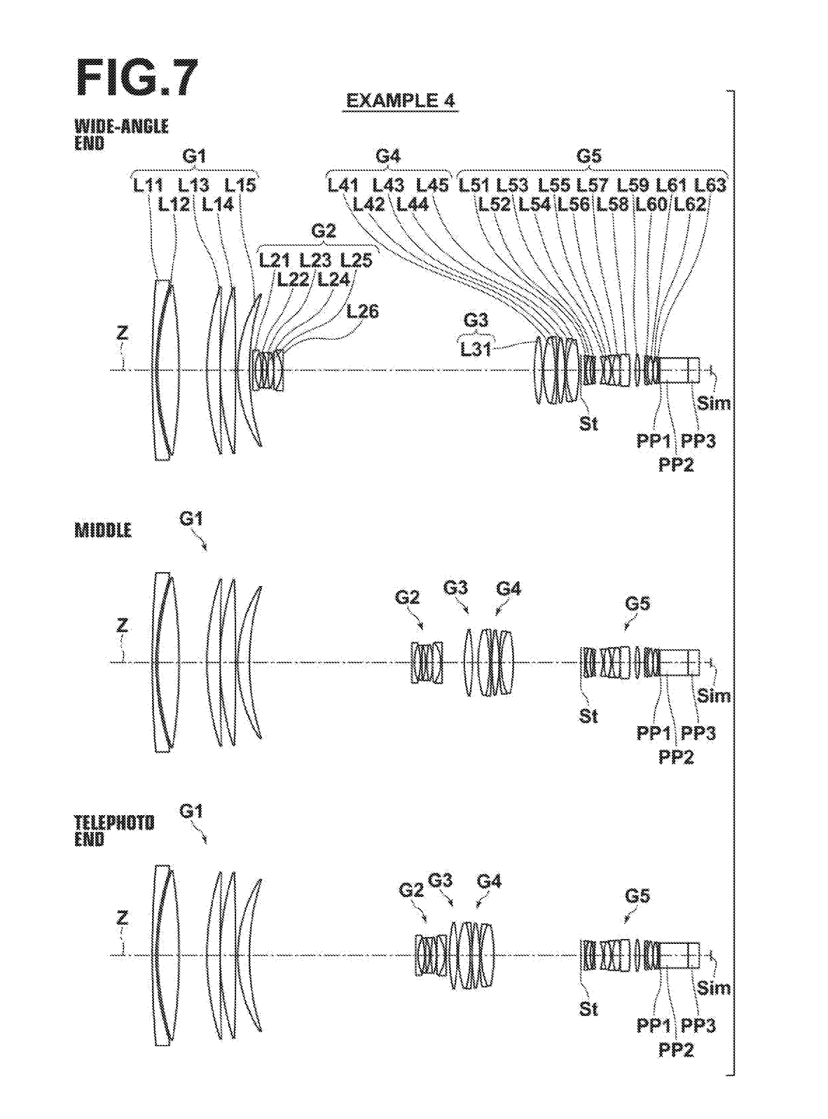

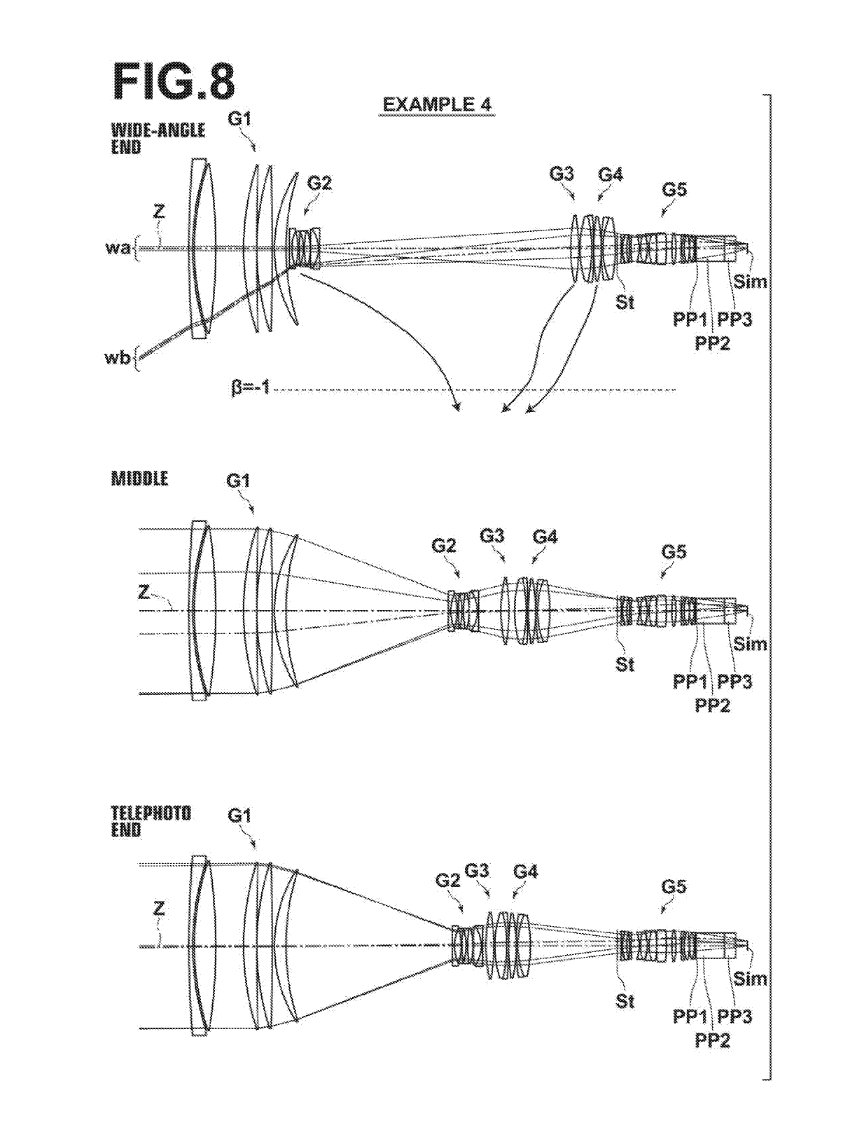

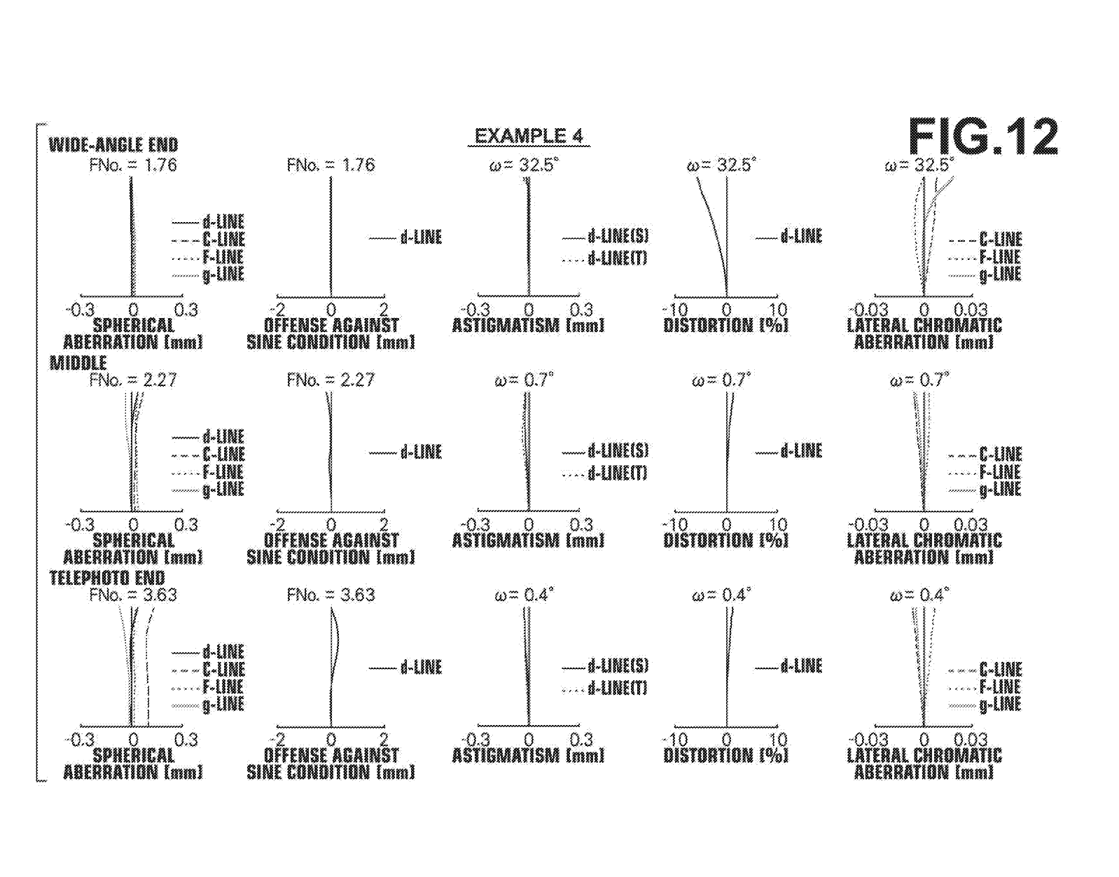

Next, a zoom lens of Example 4 is described. FIG. 7 is a sectional view illustrating the lens configuration of the zoom lens of Example 4, and FIG. 8 is a diagram showing optical paths through the zoom lens. The zoom lens of Example 4 is formed by the same number of lenses as the zoom lens of Example 1. Table 13 shows basic lens data of the zoom lens of Example 4, Table 14 shows data about specifications of the zoom lens, Table 15 shows data about variable surface distances of the zoom lens, Table 16 shows data about aspheric coefficients of the zoom lens, and FIG. 12 shows aberration diagrams of the zoom lens.

TABLE 13
Example 4 - Lens Data

| Surface | Radius of | Surface | | | |
|---|---|---|---|---|---|
| No. | Curvature | Distance | nd | νd | θg, f |
| 1 | 1404.7647 | 4.4000 | 1.83400 | 37.16 | 0.57759 |
| 2 | 331.7428 | 2.0290 | | | |
| 3 | 330.6824 | 25.1725 | 1.43387 | 95.18 | 0.53733 |
| 4 | −684.6165 | 32.8963 | | | |
| 5 | 332.8725 | 15.4555 | 1.43387 | 95.18 | 0.53733 |
| 6 | 3192.0621 | 0.1200 | | | |
| 7 | 330.0570 | 18.0043 | 1.43387 | 95.18 | 0.53733 |
| 8 | −4225.7159 | 2.9113 | | | |
| 9 | 173.7787 | 13.4351 | 1.43875 | 94.66 | 0.53402 |
| 10 | 294.8116 | DD[10] | | | |
| *11 | 3646.4256 | 2.8000 | 1.91082 | 35.25 | 0.58224 |
| 12 | 54.3093 | 7.3207 | | | |
| 13 | −83.4371 | 1.6000 | 2.00100 | 29.13 | 0.59952 |
| 14 | 337.9217 | 4.5408 | | | |
| 15 | −62.1882 | 1.6000 | 1.95375 | 32.32 | 0.59015 |
| 16 | 128.3598 | 6.5865 | 1.89286 | 20.36 | 0.63944 |
| 17 | −75.9599 | 0.1200 | | | |
| 18 | 629.8856 | 9.4791 | 1.79504 | 28.69 | 0.60656 |
| 19 | −42.5230 | 1.6200 | 1.77250 | 49.60 | 0.55212 |
| 20 | 2233.5230 | DD[20] | | | |
| 21 | 185.1580 | 9.3099 | 1.49700 | 81.54 | 0.53748 |
| *22 | −216.7260 | DD[22] | | | |
| 23 | 135.0164 | 14.0074 | 1.43875 | 94.66 | 0.53402 |
| 24 | −170.1053 | 2.0000 | 1.59270 | 35.31 | 0.59336 |
| 25 | −547.0734 | 0.2500 | | | |
| *26 | 212.2662 | 8.7456 | 1.43875 | 94.66 | 0.53402 |
| 27 | −201.9044 | 0.1200 | | | |
| 28 | 255.6587 | 2.0000 | 1.80000 | 29.84 | 0.60178 |
| 29 | 100.2233 | 14.6056 | 1.43875 | 94.66 | 0.53402 |
| 30 | −192.7222 | DD[30] | | | |
| 31(stop) | ∞ | 4.4530 | | | |
| 32 | −327.4803 | 1.5000 | 1.72916 | 54.68 | 0.54451 |
| 33 | 69.9336 | 0.1200 | | | |
| 34 | 45.9379 | 5.2438 | 1.84661 | 23.88 | 0.62072 |
| 35 | 80.2736 | 3.2540 | | | |
| 36 | −136.5718 | 1.5000 | 1.48749 | 70.24 | 0.53007 |
| 37 | 172.9017 | 9.6930 | | | |
| 38 | −48.1573 | 1.5996 | 1.95375 | 32.32 | 0.59015 |
| 39 | 64.0378 | 7.9580 | 1.84661 | 23.88 | 0.62072 |
| 40 | −45.9067 | 0.2385 | | | |
| 41 | −49.7226 | 1.8719 | 1.80100 | 34.97 | 0.58642 |
| 42 | 50.1721 | 8.9651 | 1.80400 | 46.58 | 0.55730 |
| 43 | −90.0272 | 0.1198 | | | |
| 44 | 379.5125 | 11.4833 | 1.51742 | 52.43 | 0.55649 |
| 45 | −145.3944 | 6.4985 | | | |
| 46 | 185.6172 | 4.7307 | 1.54814 | 45.78 | 0.56859 |
| 47 | −90.8051 | 5.4933 | | | |
| 48 | 144.8094 | 1.4061 | 1.95375 | 32.32 | 0.59015 |
| 49 | 44.8523 | 2.4761 | | | |
| 50 | 45.7750 | 6.4411 | 1.51633 | 64.14 | 0.53531 |
| 51 | −73.1882 | 0.1199 | | | |
| 52 | 61.3330 | 5.4690 | 1.48749 | 70.24 | 0.53007 |
| 53 | −58.5284 | 1.3999 | 1.95375 | 32.32 | 0.59015 |
| 54 | −429.0874 | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 13.9324 | | | |

TABLE 14
Example 4 - Specifications (d-line)

| | Wide Angle End | Middle | Telephoto End |
|---|---|---|---|
| Zoom Magnification | 1.0 | 48.0 | 77.0 |
| f′ | 9.30 | 446.43 | 716.14 |
| Bf′ | 44.06 | 44.06 | 44.06 |
| FNo. | 1.76 | 2.27 | 3.63 |
| 2ω[°] | 65.0 | 1.4 | 0.8 |

TABLE 15
Example 4 - Distances with respect to Zoom

| | Wide Angle End | Middle | Telephoto End |
|---|---|---|---|
| DD[10] | 4.1494 | 191.9872 | 196.6227 |
| DD[20] | 296.5791 | 26.5197 | 3.9711 |
| DD[22] | 1.5430 | 6.4538 | 1.2477 |
| DD[30] | 2.3959 | 79.7067 | 102.8260 |

TABLE 16
Example 4 - Aspheric Coefficients

| Surface | | | |
|---|---|---|---|
| No. | 11 | 22 | 26 |
| KA | 1.0000000E+00 | 1.0000000E+00 | 1.0000000E+00 |
| A3 | 2.7541588E−22 | −8.9652271E−22 | 6.6507804E−22 |
| A4 | 2.2200270E−07 | 1.5442509E−07 | −2.6398668E−07 |
| A5 | 3.6655960E−09 | −5.7414857E−09 | −1.0060099E−08 |
| A6 | 3.5909489E−11 | 1.4641121E−10 | 3.5807861E−10 |
| A7 | −1.9924682E−11 | 1.9156089E−12 | −2.2883080E−12 |
| A8 | 7.9185956E−13 | −9.8085610E−14 | −1.3269105E−13 |
| A9 | −5.7638394E−15 | 5.8482396E−16 | 2.9778250E−15 |
| A10 | −1.5115490E−16 | 5.8511099E−18 | −1.8171297E−17 |

Table 17 shows values corresponding to the condition expressions (1) to (10) of the zoom lenses of Examples 1 to 4. In all the examples, the d-line is used as a reference wavelength, and the values shown in the Table 17 below are with respect to the reference wavelength.

TABLE 17

| | Condition | | | | |
|---|---|---|---|---|---|
| No. | Expression | Example 1 | Example 2 | Example 3 | Example 4 |
| (1) | νd21 | 31.31 | 32.32 | 31.31 | 35.25 |
| (2) | f2/f21 | 0.463 | 0.390 | 0.478 | 0.490 |
| (3) | fw/f21 | −0.149 | −0.127 | −0.157 | −0.154 |
| (4) | L23νd − | 11.96 | 8.49 | 11.96 | 11.96 |
| | L24νd | | | | |
| | L26νd − | 21.15 | 23.86 | 21.19 | 20.91 |
| | L25νd | | | | |
| (5) | ndL11 | 1.83400 | 1.83400 | 1.83400 | 1.83400 |
| (6) | νdL11 | 37.16 | 37.16 | 37.16 | 37.16 |
| (7) | LABnd | 1.95375 | 1.95375 | 1.95375 | 1.95375 |
| (8) | LAnd − LCnd | 0.46626 | 0.46626 | 0.46626 | 0.46626 |
| (9) | LABνd | 32.32 | 32.32 | 32.32 | 32.32 |
| (10) | νdG34n | 32.58 | 32.58 | 32.58 | 32.58 |

As can be seen from the above-described data, all the zoom lenses of Examples 1 to 4 satisfy condition expressions (1) to (10), and are a high performance zoom lens having suppressed fluctuations of primary and secondary longitudinal chromatic aberrations and primary and secondary lateral chromatic aberrations during magnification change while achieving a high magnification ratio of 70× or more.

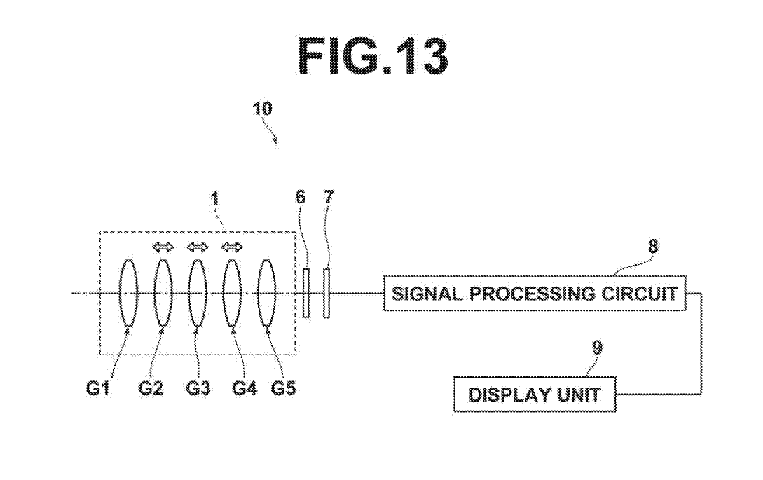

Next, an imaging apparatus according to an embodiment of the disclosure is described. FIG. 13 is a diagram illustrating the schematic configuration of an imaging apparatus employing the zoom lens of the embodiment of the disclosure, which is one example of the imaging apparatus of the embodiment of the disclosure. It should be noted that the lens groups are schematically shown in FIG. 13. Examples of the imaging apparatus may include a video camera, an electronic still camera, etc., which include a solid-state image sensor, such as a CCD (Charge Coupled Device) or CMOS (Complementary Metal Oxide Semiconductor), serving as a recording medium.

The imaging apparatus 10 shown in FIG. 13 includes a zoom lens 1; a filter 6 having a function of a low-pass filter, etc., disposed on the image plane side of the zoom lens 1; an image sensor 7 disposed on the image plane side of the filter 6; and a signal processing circuit 8. The image sensor 7 converts an optical image formed by the zoom lens 1 into an electric signal. As the image sensor 7, a CCD or a CMOS, for example, may be used. The image sensor 7 is disposed such that the imaging surface thereof is positioned in the same position as the image plane of the zoom lens 1.

An image taken through the zoom lens 1 is formed on the imaging surface of the image sensor 7. Then, a signal about the image outputted from the image sensor 7 is processed by the signal processing circuit 8, and the image is displayed on a display unit 9.

The imaging apparatus 10 of this embodiment is provided with the zoom lens 1 of the disclosure, and therefore allows obtaining a high image-quality image at high magnification.

The present disclosure has been described with reference to the embodiments and the examples. However, the invention is not limited to the above-described embodiments and examples, and various modifications may be made to the disclosure. For example, the values of the radius of curvature, the surface distance, the refractive index, the Abbe number, etc., of each lens element are not limited to the values shown in the above-described numerical examples and may be different values.

What is claimed is:

1. A zoom lens consists of, in order from the object side, a first lens group having a positive refractive power, a second lens group having a negative refractive power, a third lens group having a positive refractive power, a fourth lens group having a positive refractive power, and a fifth lens group having a positive refractive power,
wherein the first lens group and the fifth lens group are fixed relative to the image plane during magnification change,
the second lens group, the third lens group, and the fourth lens group are moved to change distances therebetween during magnification change,
the second lens group is moved from the object side toward the image plane side during magnification change from the wide angle end to the telephoto end,
the second lens group comprises at least one positive lens and at least four negative lenses including three negative lenses that are successively disposed from the most object side, and the second lens group and an L21 negative lens, which is the most object-side lens of the negative lenses of the second lens group, satisfy the condition expressions (1) and (2) below:
25<νd21<45 (1), and
0.31<f2/f21<0.7 (2),
where νd21 is an Abbe number with respect to the d-line of the L21 negative lens, f2 is a focal length with respect to the d-line of the second lens group, and f21 is a focal length with respect to the d-line of the L21 negative lens.

2. The zoom lens as claimed in claim 1, wherein the condition expression (3) below is satisfied:
−0.3<fw/f21<−0.105 (3),
where fw is a focal length with respect to the d-line of the entire system at the wide angle end.

3. The zoom lens as claimed in claim 1, wherein the second lens group consists of, in order from the object side, the L21 negative lens, an L22 negative lens, a cemented lens formed by, in order from the object side, an L23 negative lens having a biconcave shape and an L24 positive lens that are cemented together, and a cemented lens formed by, in order from the object side, an L25 positive lens having a convex surface toward the image plane side and an L26 negative lens that are cemented together.

4. The zoom lens as claimed in claim 3, wherein the condition expression (4) below is satisfied:
L23νd−L24νd<L26νd−L25νd (4),
where L23νd is an Abbe number with respect to the d-line of the L23 negative lens, L24νd is an Abbe number with respect to the d-line of the L24 positive lens, L26νd is an Abbe number with respect to the d-line of the L26 negative lens, and L25νd is an Abbe number with respect to the d-line of the L25 positive lens.

5. The zoom lens as claimed in claim 1, wherein the first lens group consist of, in order from the object side, an L11 negative lens, an L12 positive lens, an L13 positive lens, an L14 positive lens, and an L15 positive lens having a meniscus shape with the convex surface toward the object side, and
the condition expressions (5) and (6) below are satisfied:
1.75<ndL11 (5), and
νdL11<45 (6),
where ndL11 is a refractive index with respect to the d-line of the L11 negative lens, and νdL11 is an Abbe number with respect to the d-line of the L11 negative lens.

6. The zoom lens as claimed in claim 1, wherein the position of the fourth lens group at the telephoto end is nearer to the object side than the position of the fourth lens group at the wide angle end.

7. The zoom lens as claimed in claim 1, wherein the distance between the second lens group and the third lens group at the telephoto end is smaller than the distance between the second lens group and the third lens group at the wide angle end.

8. The zoom lens as claimed in claim 1, wherein the fifth lens group comprises at least two negative lenses, and
the condition expression (7) below is satisfied:
1.90<LABnd (7),
where LABnd is an average value of a refractive index LAnd with respect to the d-line of an LA negative lens that is the first negative lens from the image plane side of the fifth lens group and a refractive index LBnd with respect to the d-line of an LB negative lens that is the second negative lens from the image plane side of the fifth lens group.

9. The zoom lens as claimed in claim 8, wherein the condition expression (8) below is satisfied:
0.42<LAnd−LCnd (8),
where LAnd is a refractive index with respect to the d-line of the LA negative lens that is the first negative lens from the image plane side of the fifth lens group, and LCnd is a refractive index with respect to the d-line of an LC positive lens that is the first positive lens from the image plane side of the fifth lens group.

10. The zoom lens as claimed in claim 1, wherein the fifth lens group comprises at least two negative lenses, and
the condition expression (9) below is satisfied:
25<LABνd<40 (9),
where LABνd is an average value of an Abbe number LAνd with respect to the d-line of an LA negative lens that is the first negative lens from the image plane side of the fifth lens group and an Abbe number LBνd with respect to the d-line of an LB negative lens that is the second negative lens from the image plane side of the fifth lens group.

11. The zoom lens as claimed in claim 1, wherein, during magnification change from the wide angle end to the telephoto end, each of the second lens group and a third-fourth combined lens group, which is formed by the third lens group and the fourth lens group, simultaneously passes through a point at which the imaging magnification of the lens group is −1×.

12. The zoom lens as claimed in claim 1, wherein the distance between the third lens group and the fourth lens group is the greatest at a point on the wide angle side of a point at which the imaging magnification of a third-fourth combined lens group, which is formed by the third lens group and the fourth lens group, is −1×.

13. The zoom lens as claimed in claim 1, wherein a third-fourth combined lens group, which is formed by the third lens group and the fourth lens group, comprises at least one negative lens, and
the condition expression (10) below is satisfied:
29<νdG34n<37 (10),
where νdG34n is an average value of Abbe numbers with respect to the d-line of all negative lenses of the third-fourth combined lens group.

14. The zoom lens as claimed in claim 1, wherein the condition expression (1-1) and/or (2-1) below is satisfied:
28<νd21<40 (1-1),
0.36<f2/f21<0.55 (2-1).

15. The zoom lens as claimed in claim 2, wherein the condition expression (3-1) below is satisfied:
−0.2<fw/f21<−0.11 (3-1).

16. The zoom lens as claimed in claim 5, wherein the condition expression (5-1) and/or (6-1) below is satisfied:
1.80<ndL11 (5-1),
νdL11<40 (6-1).

17. The zoom lens as claimed in claim 8, wherein the condition expression (7-1) below is satisfied:
1.94<LABnd (7-1).

18. The zoom lens as claimed in claim 9, wherein the condition expression (8-1) below is satisfied:
0.45<LAnd−LCnd (8-1).

19. The zoom lens as claimed in claim 10, wherein the condition expression (9-1) below is satisfied:
30<LABνd<36 (9-1).

20. An imaging apparatus comprising the zoom lens as claimed in claim 1.
